(19) United States
(12) Patent Application Publication
(10) Pub. No.: US 2007/0214309 A1
(43) Pub. Date: Sep. 13, 2007

(54) NONVOLATILE STORAGE DEVICE AND DATA WRITING METHOD THEREOF

(75) Inventors: Masanori MATSUURA, Osaka (JP); Yasushi GOHOU, Osaka (JP); Syunichi IWANARI, Kyoto (JP); Shinichi TOKUMITSU, Kyoto (JP); Masahiro NAKANISHI, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/670,670

(22) Filed: Feb. 2, 2007

(30) Foreign Application Priority Data
Mar. 7, 2006 (JP) 2006/061875

(51) Int. Cl. G06F 12/00

(52) U.S. Cl. 711/103; 711/170

(57) ABSTRACT

A nonvolatile storage device according to the invention is a nonvolatile storage device into which data is inputted from an external device on a sector unit, and includes: a main memory which is nonvolatile and in which data is written on a page unit, the page unit being larger than the sector unit; an auxiliary memory which holds at least a single page worth of the input data; a memory judging unit that judges whether or not data held in the auxiliary memory is equal to or larger than data of the page unit; and a memory control unit that writes, in a new page of the main memory on the page unit, the data held in the auxiliary memory when the memory judgment unit judges that the data held in the auxiliary memory is equal to or larger than data of the page unit.

### BACKGROUND OF THE INVENTION

(1) Field of the Invention

The present invention relates to a nonvolatile storage device and a data writing method of the nonvolatile storage device, and more particularly, to a nonvolatile storage device: which includes an auxiliary memory, and a main memory in which data is written on a page unit; and into which data on a sector unit which is smaller than the page unit is inputted.

(2) Description of the Related Art

Demand for nonvolatile storage devices which includes rewritable nonvolatile main memories grows, particularly, semiconductor memory cards. The semiconductor memory cards have various types. As one of the types, an SD memory card™ is known.

FIG. 1 is a block diagram showing a configuration of a nonvolatile storage system including a conventional nonvolatile storage device. The nonvolatile storage system shown in FIG. 1 includes an access device 100 such as a digital still camera or a personal computer (PC), and a nonvolatile storage device 1110.

The nonvolatile storage device 1110 is, for example, an SD memory card and includes a flash memory 1130 serving as a nonvolatile main memory 1130 and a memory controller 1120 for controlling the flash memory 1130. The memory controller 1120 performs read or write control to the flash memory 1130 depending on a data read command or a data write command issued from the access device 100.

The nonvolatile storage device 1110 (SD memory card or the like) is installed in the access device 100, such as a personal computer or the like, and the nonvolatile storage device 1110 (SD memory card or the like) is regarded as a removal disk on the access device 100 side and managed by a FAT file system. The following describes a case when data is accessed with this configuration.

The FAT file system is a system which commands a data read/write operation on a cluster basis in normal times using a file allocation table (FAT) when a file or data is recorded in a recording apparatus. The cluster is a unit made up of “sectors” which are minimum units for writing data in the FAT file system.

In the flash memory 1130, conventionally, a page size which is a write unit of the flash memory 1130 is equal to the sector size which is a minimum unit for writing data in the FAT file system, for example, 512 bytes. However, in recent years, in order to meet the needs of large-capacity and high-speed flash memory 1130, the page size is becoming larger than the sector size, and the minimum unit for writing data in the flash memory 1130 is not the sector size any longer. For example, as a multi-level cell NAND flash memory, a flash memory 1130 with a page size of 2 Kbytes (4 sectors) has become mainstream.

The following describes a case where 1 sector worth of data with a logical sector address 0 is rewritten in the nonvolatile storage device 1110, such as a memory card constituted by the flash memory 1130 with a page size which is larger than a sector size. Note that it is assumed that 4 sectors worth of data with logical sector addresses 0 to 3 have already been written in the nonvolatile storage device 1110.

In the nonvolatile storage device 1110, the 3 sectors worth of data previously written in the flash memory 1130 and with the logical sector addresses 1 to 3 are read, and the read data of the 3 sectors is written in a free space on a head page of the flash memory 1130 together with 1 sector worth of data with the logical sector address 0. These read and write processes of the data of 3 sectors are referred to as the saving process hereinafter. As a technique for such rewrite process, for example, a technique U.S. Pat. No. 6,760,805 is disclosed.

An outline of a procedure of the “rewrite method with the saving process” is as follows. Note that in a physical block of the flash memory 1130, sectors are sequentially arranged in a logical order, in other words, an order from a lower address side (lower address values) of a physical block, as logical sector numbers 0, 1, . . . ,. In this case, the physical block is a minimum unit for erasing data in the flash memory 1130. One physical block contains a plurality of pages.

The data is written by the procedure described as follows.

1. A step of receiving a logical address specified by the access device 100.

2. A step of converting a logical address into a physical address on a main memory.

3. A step of reading unchanged old data (for example, plural pieces of data respectively having sector addresses 1 to 3) into a buffer (SRAM) when only 1 sector of data stored in a page (for example, data having a sector address 0) is rewritten into new data.

4. A step of writing new data in the buffer (SRAM).

5. A step of writing, in an erased physical block which is different from the physical block including the page, the data temporarily stored in the buffer (SRAM).

6. A step of allocating, to an invalid physical block, the physical block in which the old data has been recorded.

7. A step of erasing the content of the invalid physical block.

As is apparent from the aforementioned description, the “rewrite method with the saving process” requires a write process of one page including the sector of the unchanged old data, even when 1 sector is rewritten. For this reason, the process is a cumbersome time-consuming process.

In order to address this problem, for example, a technique described in Japanese Unexamined Patent Application Publication No. 5-27924 is disclosed.

In a flash memory of a nonvolatile storage device disclosed in Japanese Unexamined Patent Application Publication No. 5-27924, a sector arrangement order of a physical block is not limited to a logical order, and data is written from a lower page side of the physical block in an order of write commands. For every page in which each sector is written, recording states are managed, such as whether or not valid data is written, or whether or not data is invalid because the data is old data. This method is referred to as the “recordable rewrite method” hereinafter.

In this recordable rewrite method, each time an access device commands data to be written, the data saving process is not performed. For this reason, the write operation itself is performed at a relatively high speed. However, garbage collection (the step of collecting only valid sectors from a predetermined block, writing the valid sectors in another erased block, and erasing the invalid block) is necessary at certain timing. The garbage collection is also performed in the “rewrite method with the saving process”.

### SUMMARY OF THE INVENTION

However, the garbage collection in the “rewrite method with the saving process” and the “recordable rewrite method” requires relatively long time. When the garbage correction is performed many times, an operation speed of a nonvolatile storage element consequently decreases.

Therefore, the present invention has been conceived in consideration of the above problems, and the object is to provide a nonvolatile storage device which can reduce the number of times of performing the garbage collection and which can write data at a high speed.

In order to achieve the above object, the nonvolatile storage device according to the present invention is a nonvolatile storage device into which data is inputted from an external device on a sector unit, and the device includes: a main memory which is nonvolatile and in which data is written on a page unit, the page unit being larger than the sector unit; an auxiliary memory which holds at least a single page worth of the input data; a memory judging unit that judges whether or not data held in the auxiliary memory is equal to or larger than data of the page unit; and a memory control unit that writes, in a new page of the main memory on the page unit, the data held in the auxiliary memory when the memory judgment unit judges that the data held in the auxiliary memory is equal to or larger than data of the page unit.

According to this configuration, since data is written in the main memory on the page unit which does not include a sector of old data, creation of invalid pages can be reduced in comparison with a conventional case in which data is written in a main memory on a page unit which includes a sector of old data. Thus, since the number of invalid pages decreases, the number of times of garbage collection can be reduced. More specifically, since the saving process to be performed when data is written in the main memory need not be performed, the number of times of garbage collection can be reduced. For this reason, data can be written in a high speed. Furthermore, since the number of times to be written in the main memory can be reduced, the rewriting lifetime of the nonvolatile storage device can be extended.

Furthermore, it is possible that the auxiliary memory holds the input data and an address of the input data, the nonvolatile storage device further includes: an address judgment unit that judges whether or not the address held in the auxiliary memory is identical to an address of data inputted newly from the external device; and a CPU that writes the new input data in the auxiliary memory and that controls the memory control unit, wherein the auxiliary memory holds data management flags each of which indicates an order in which each held data is written, and the CPU: writes the new input data in an area different from an area in which data judged to be identical to the new input data in the auxiliary memory is held when the address judgment unit judges that the address held in the auxiliary memory is identical to the address of the new input data; sets information in a data management flag corresponding to the new input data, the information indicating that the new input data is written after the data judged to be identical to the new input data is written; and determines data which the memory control unit writes in the main memory, based on the data management flag.

According to this configuration, when data of the same address is inputted from the external device, plural pieces of data of the same address are held in the auxiliary memory, and only the latest new input data is written in the main memory, so that the number of times to be written in the main memory can be reduced. In this manner, since creation of invalid pages decreases, the number of times of garbage collection can be reduced. Furthermore, the data management flag held in the auxiliary memory is checked to make the CPU possible to easily judge the latest data among the plural pieces of data of the same address held in the auxiliary memory. Furthermore, the input data of the address identical to that of the data held in the auxiliary memory is held in an area different from that of the data of the same address held in the auxiliary memory. In this manner, when the input data fails to be written in the auxiliary memory, there is an advantage in that at least the old data held in the auxiliary memory is not lost.

Furthermore, it is possible that the auxiliary memory holds the input data and an address of the input data, the nonvolatile storage device further includes: an address judgment unit that judges whether or not an address held in the auxiliary memory is identical to an address of data inputted newly from the external device; and a CPU that writes the new input data in the auxiliary memory and that controls the memory control unit, and when the address judgment unit judges that the address held in the auxiliary memory is identical to the address of the new input data, the CPU overwrites the new input data in an area in which data judged to be identical to the new input data in the auxiliary memory is held.

According to this configuration, when data of the same address inputted from the external device, previously input data is temporarily stored in the auxiliary memory. When new data of the same address is inputted from the external device, the data is overwritten. In this manner, since only the latest new input data can be written in the main memory, the number of times to be written in the main memory can be reduced. For this reason, since creation of invalid pages decreases, the number of times of garbage collection can be reduced. Therefore, data can be written at a high speed. In addition, the number of times to be written in the main memory decreases, which makes it possible to extend the rewriting lifetime of the nonvolatile storage device. Since the data is overwritten in the auxiliary memory, the storage capacity of the auxiliary memory can be effectively used.

Furthermore, it is possible that the memory judgment unit judges whether or not the auxiliary memory is full, and the memory control unit writes, in the main memory, the data held in the auxiliary memory when the memory judgment unit judges that the auxiliary memory is full.

According to this configuration, even when the data inputted from the external device is not transferred in a logical address order, but is transferred halfway or from the end of the physical addresses of the main memory corresponding to the logical addresses, the data can be held in the auxiliary memory. Thus, after the plural pieces of data of the logical addresses of the page unit corresponding to the physical addresses of the main memory are held in the auxiliary memory, the data can be written in the main memory. For this reason, creation of invalid pages decreases, which makes it possible to reduce the number of times of garbage collection. Furthermore, the efficiency of data write can be improved.

Furthermore, it is possible that the memory judgment unit is implemented by hardware, the nonvolatile storage device further includes a notifying unit that notifies the CPU of a result of the judgment made by the memory judgment unit, the CPU controls the memory control unit based on the result of the judgment notified by the notifying unit, and the memory control unit writes, in the new page of the main memory on the page unit, the data held in the auxiliary memory under the control of the CPU.

According to this configuration, the notifying unit notifies the CPU that the auxiliary memory is full. In this manner, since the CPU need not check a state of the auxiliary memory, a process sequence of the CPU can be simplified.

Furthermore, it is possible that the memory judgment unit judges whether or not the auxiliary memory is full based on the number of valid data management flags held in the auxiliary memory.

According to this configuration, the memory judgment unit can easily judge whether the auxiliary memory is full.

Furthermore, it is possible that: the memory judgment unit judges whether or not the auxiliary memory is full; when the memory judgment unit judges that the auxiliary memory is full, the memory control unit writes, in the main memory, the data held in the auxiliary memory; and the CPU writes the new input data in the auxiliary memory after the judgment of the memory judgment unit is made.

According to the configuration, since the new input data is written in the auxiliary memory after the judgment made by the memory judgment unit, subsequent processes continue even when the auxiliary memory is full by writing the new input data in the auxiliary memory. More specifically, in the state in which the auxiliary memory is full, the subsequent processes can be judged after an address of data inputted next from the external device is compared with the data held in the auxiliary memory. Therefore, when plural pieces of data of the same addresses are received, even when the auxiliary memory is full, the data may be overwritten in the auxiliary memory, and the timing to be written in the auxiliary memory can be delayed. In this manner, a high-speed write operation of the nonvolatile storage device can be achieved. Furthermore, the capacity of the auxiliary memory can be effectively used.

Furthermore, it is possible that the nonvolatile storage device further includes an updating judgment unit that judges whether or not the input data is frequently updated, wherein specific data which is data judged to be frequently updated by the updating judgment unit is written in the main memory in order of priority, the priority of the specific data being lower than a priority of data other than the specific data.

According to this configuration, the data to be frequently updated (directory entry, key information, or the like) is held in the auxiliary memory and written in the main memory at the end of the processes or the like. Therefore, the data need not be written in the main memory each time the data to be frequently updated is received, and the number of times to be rewritten in the main memory can decrease. With this, as unnecessary writing is not performed, the number of garbage collection can be reduced. Furthermore, the lifetime of the nonvolatile storage device can be extended.

Furthermore, it is possible that the nonvolatile storage device further includes a specific address judgment unit that judges whether or not an address of the input data is identical to a specific address, wherein specific data which is data having the specific address is written in the main memory in order of priority, the priority of the specific data being lower than a priority of data other than the specific data.

According to the configuration, the data of the specific address to be frequently updated (FAT data or the like) is held in the auxiliary memory and written in the main memory at the end of the processes or the like. Therefore, the data need not be written in the main memory each time the data of the specific address to be frequently updated is received, and the number of times to be rewritten in the main memory can be reduced. Therefore, since unnecessary writing is not performed, the number of times of garbage collection can be reduced. Furthermore, the lifetime of the nonvolatile storage device can be extended.

Furthermore, it is possible that the auxiliary memory holds a specific area flag indicating whether or not each held data is the specific data.

According to the configuration, data in a specific area held in the auxiliary memory can be easily judged. Furthermore, a plurality of specific areas can be arbitrarily set.

Furthermore, it is possible that an area in which the specific data is held can be freely set in the auxiliary memory.

According to this configuration, a plurality of specific areas can be arbitrarily set. Since an arbitrary area can be set as a specific area, the capacity of the auxiliary memory can be effectively used.

Furthermore, it is possible that the auxiliary memory holds a write completion flag indicating whether or not each held data is correctly written in the auxiliary memory.

According to the configuration, it can be easily judged whether data is correctly written in the auxiliary memory. Thus, the reliability of the data held in the auxiliary memory can be improved.

Furthermore, it is possible that the auxiliary memory holds a transfer completion flag indicating whether or not each held data is written in the main memory.

According to the configuration, it can be easily judged whether the data held in the auxiliary memory is data previously held in the main memory and is allowed to be overwritten. Furthermore, it can be easily judged whether data is correctly written in the main memory, and the reliability of the data held in the main memory can be improved.

Furthermore, the auxiliary memory may be a nonvolatile RAM.

According to the configuration, after the data is written in the auxiliary memory, even when the power supply fails before the data is written in the main memory, the data remains in the auxiliary memory. For this reason, the data in the nonvolatile storage device is not lost. In addition, when the data is written in the auxiliary memory, the external device can be notified of completion of writing, and a writing speed of the nonvolatile storage device can be improved.

Furthermore, the auxiliary memory may be one of a ferroelectric memory (FeRAM), a magnetoresistive random access memory (MRAM), an ovonic unified memory (OUM), and a resistance RAM (RRAM).

Furthermore, the address judgment unit may be implemented by hardware.

According to the configuration, the address judgment unit as the hardware can judge whether an address of data held in the auxiliary memory is identical to an address of the data newly inputted from the external device, and an operation speed can be increased. Furthermore, the number of processes of the CPU can be reduced.

Furthermore, the data writing method according to the present invention is a data writing method for use in a nonvolatile storage device including a nonvolatile main memory in which data is inputted from an external device on a sector unit and in which data is written on a page unit, the page unit being larger than the sector unit, and the method includes: holding the input data in an auxiliary memory; judging whether or not data held in the auxiliary memory is equal to or larger than data of the page unit; and writing, in a new page of the main memory on the page unit, the data held in the auxiliary memory when the judging judges that the data held in the auxiliary memory is equal to or larger than data of the page unit.

In this manner, since the data is written in the main memory on the page unit which does not include a sector of old data, creation of invalid pages can be reduced in comparison with a conventional case in which data is written in a main memory on a page unit which includes a sector of old data. Thus, since the number of invalid pages decreases, the number of times of garbage collection can be reduced. More specifically, since a saving process to be performed when data is written in the main memory need not be performed, the number of times of garbage collection can be reduced. For this reason, data can be written at a high speed. Furthermore, since the number of times to be written in the main memory can be reduced, the rewriting lifetime of the nonvolatile storage device can be extended.

Note although as a conventional art, Japanese Unexamined Patent Publication No. 7-200418 discloses a technique which uses a nonvolatile auxiliary memory as in the present invention, it does not disclose the reduced saving process described according to the present invention.

The present invention can provide a nonvolatile storage device which can reduce the number of times of garbage collection and write data at a high speed.

### FURTHER INFORMATION ABOUT TECHNICAL BACKGROUND TO THIS APPLICATION

Japanese Patent application No. 2006-061875 filed on Mar. 7, 2006 is incorporated herein by reference.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a conventional nonvolatile storage system.

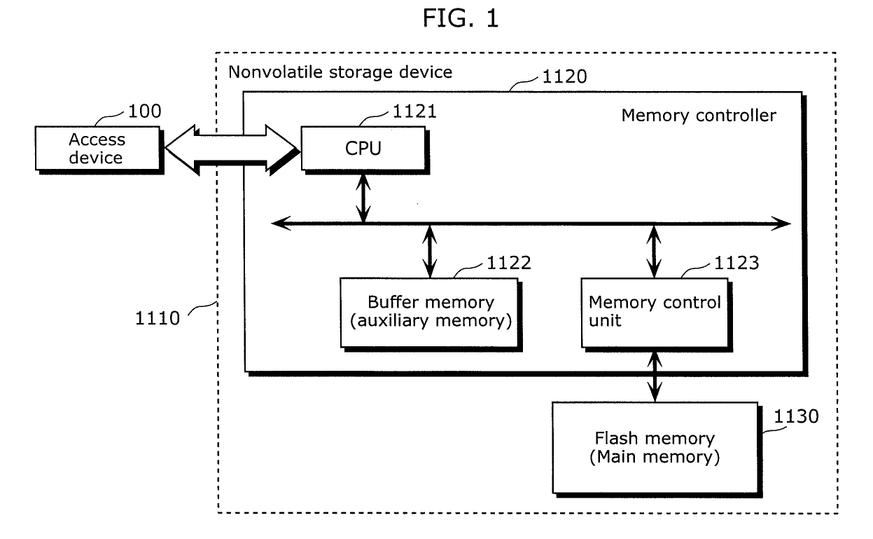

FIG. 2 is a block diagram of a nonvolatile storage system according to the first embodiment.

FIG. 3 is a diagram showing a configuration of the flash memory 130.

FIG. 4 is a diagram showing a configuration of a physical block of the flash memory 130.

FIG. 5 is a diagram showing a configuration of data held in the buffer memory 122 according to the first embodiment.

FIG. 6 is a flow chart of a write process of the nonvolatile storage device 110 according to the first embodiment.

FIG. 7 is a diagram showing a flow of a rewrite process of the nonvolatile storage device 110 according to the first embodiment.

FIG. 8 is a diagram showing a flow of a rewrite process of a conventional nonvolatile storage device.

FIG. 9 is a diagram showing a flow of a rewrite process of the conventional nonvolatile storage device.

FIG. 10 is a flow chart of a write process of a nonvolatile storage device 110 according to the second embodiment.

FIG. 11 is a diagram showing a flow of a rewrite process of the nonvolatile storage device 110 according to the second embodiment.

FIG. 12 is a block diagram showing a configuration of the nonvolatile storage system according to the third embodiment.

FIG. 13 is a flow chart of a write process of the nonvolatile storage device 110 according to the third embodiment.

FIG. 14 is a flow chart of a write process of the nonvolatile storage device 110 according to the fifth embodiment.

FIG. 15 is a diagram showing a flow of a rewrite process of the nonvolatile storage device 110 according to the sixth embodiment.

FIG. 16 is a diagram showing a configuration of data held in the buffer memory 122 according to the eighth embodiment.

FIG. 17 is a diagram showing a flow of a rewrite process of the nonvolatile storage device 110 according to the eighth embodiment.

FIG. 18 is a diagram showing a configuration of data held in the buffer memory 122 according to the ninth embodiment.

FIG. 19 is a diagram showing a flow of a rewrite process of the nonvolatile storage device 110 according to the ninth embodiment.

FIG. 20 is a diagram showing a configuration of data held in a buffer memory 122 according to the tenth embodiment.

FIG. 21 is a diagram showing a flow of a rewrite process of the nonvolatile storage device 110 according to the tenth embodiment.

FIG. 22 is a diagram showing a flow of a rewrite process of the nonvolatile storage device 110 according to the eleventh embodiment.

FIG. 23 is a block diagram showing a configuration of the nonvolatile storage system according to the twelfth embodiment.

### DESCRIPTION OF THE PREFERRED EMBODIMENTS

Embodiments of a nonvolatile storage device according to the present invention are described with reference to the accompanying drawings.

### First Embodiment

A nonvolatile storage device according to the present embodiment holds, in an auxiliary memory, at least a single page worth of data on a sector unit which is inputted from an access device, and writes the data in a main memory on a page unit. In this manner, the number of writing times can be reduced. Thus, since creation of invalid pages can be reduced, the number of times of garbage collection can be reduced and the operation speed can be increased.

A configuration of the nonvolatile storage device according to the first embodiment of the present invention is described hereinafter.

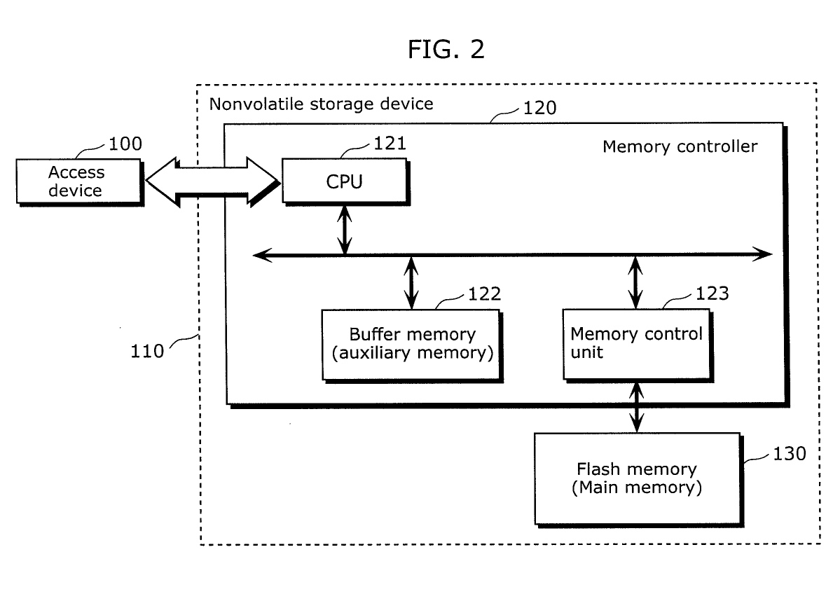

FIG. 2 is a block diagram showing the configuration of a nonvolatile storage system according to the first embodiment of the present invention. The nonvolatile storage system shown in FIG. 2 includes a nonvolatile storage device 110 and an access device 100.

The access device 100 transmits a read or write command of user data on a sector unit (to be simply referred to as data hereinafter) to the nonvolatile storage device 110. In a write operation, the access device 100 transmits write data and a logical address of the write data to the nonvolatile storage device 110. In a read operation, the access device 100 transmits a logical address of read data to the nonvolatile storage device 110 and receives data. For example, the access device 100 is a digital still camera, a personal computer, or the like.

The nonvolatile storage device 110 includes a memory controller 120 and the flash memory 130 which is a nonvolatile main memory. The nonvolatile storage device 110 is, for example, an SD memory card.

The memory controller 120 writes data inputted from the access device 100 into the flash memory 130 in response to a write command from the access device 100. Furthermore, the memory controller 120 reads data from the flash memory 130 in response to a read command from the access device 100 and outputs the data to the access device 100. The memory controller 120 includes a CPU 121, a buffer memory 122, and a memory control unit 123.

The CPU 121 entirely controls the nonvolatile storage system, such as transmitting and receiving data to and from the access device 100 and managing addresses in the write and read operations of data in/from the flash memory 130. Furthermore, the CPU 121 writes data in the buffer memory 122 and controls the memory control unit 123.

The buffer memory 122 is an auxiliary memory which temporarily stores data which is inputted from the access device 100 and is not yet written in the flash memory 130. The buffer memory 122 holds, on a sector unit, at least a single page worth of data which is inputted from the access device 100, and the page is a write unit of the flash memory 130. The buffer memory 122 is a nonvolatile RAM, for example, a ferroelectric memory (FeRAM), a magnetic recording random access memory (MRAM), an ovonic unified memory (OUM), or a resistance RAM (RRAM). The buffer memory 122 may be a volatile memory (SRAM or the like).

The memory control unit 123 controls write and read operations of data in/from the main memory 130 and the buffer memory 122.

Since a logical physical conversion process executed by the CPU 121, in other words, an address management process such as a process of converting a logical address specified by the access device 100 into a physical address of the flash memory 130 is a generally known and simple technique, the description thereof is omitted.

In the flash memory 130, data is written on a page unit larger than a sector unit. The flash memory 130 is, for example, a multi-level cell NAND flash memory.

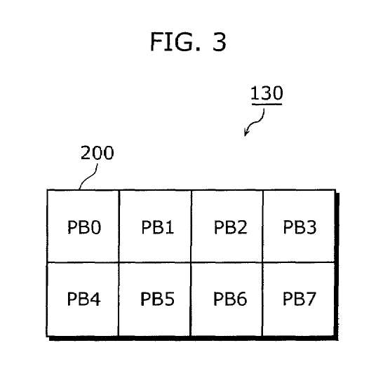

FIG. 3 is a diagram showing an example of a configuration of a physical block in the flash memory 130. The flash memory 130 shown in FIG. 3 is made up of eight physical blocks 200 (PB0 to PB7). The physical block 200 is a minimum unit for erasing data, and has a size of, for example, 256 Kbytes.

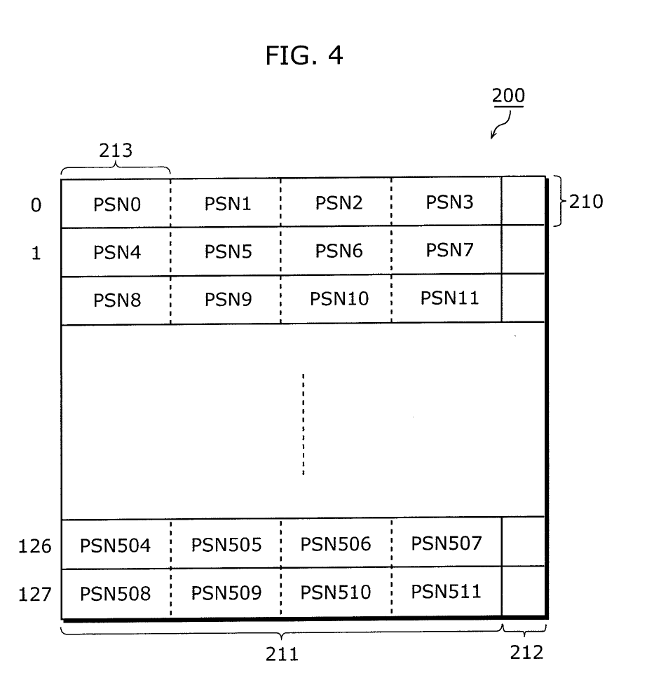

FIG. 4 is a diagram showing an example of a configuration of a physical address in the physical block 200. The physical block 200 shown in FIG. 4 is made up of 128 pages of the pages 210. The page 210 is a minimum unit for writing data in the flash memory 130 and has a size of, for example, 2 Kbytes. Each of the pages 210 includes a 2048-byte data area 211 and a 64-byte management area 212. A sector 213 which is a data unit from the access device 100 has a size of 512 bytes. 4 sectors worth of data is recorded on each of the pages 210. For example, on page 0, 4 sectors worth of data, PSN0 to PSN3, is recorded. Although the management area 212 is an area in which information required for an address management process of the CPU 121 is stored, the detailed explanation thereof is omitted.

The physical location symbols, in other words, PSN0, PSN1, . . . , PSN511 are sequentially added to the sectors from the upper left in FIG. 4. The PSN is an abbreviation of Physical Sector Number. Note that the configuration of the flash memory 130 is not limited to the ones shown in FIGS. 3 and 4.

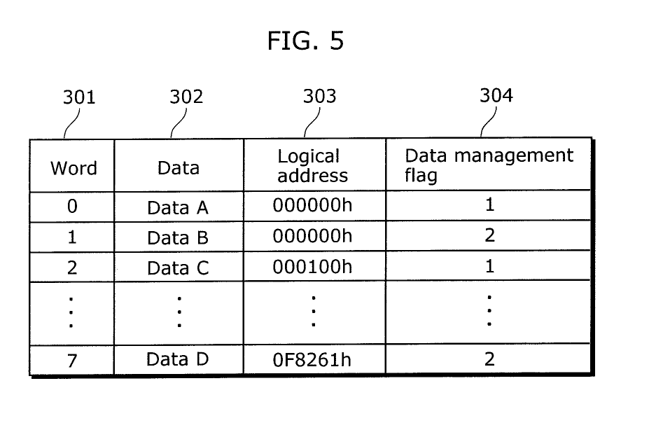

FIG. 5 is a diagram showing a configuration of data held in the buffer memory 122. As shown in FIG. 5, the buffer memory 122 has a capacity which can temporarily store a single sector worth of data in the physical block and a logical address, and holds eight words 301. Each of the words 301 includes a data area 302, a logical address area 303, and a data management flag 304. In the data area 302, data of 512 bytes corresponding to 1 sector is held. In the logical address area 303, an address on the sector unit of the data is held. The address has the number of bits (21 bits) which can identify a 1 Gbyte worth of sector. The data management flag 304 is information indicating an order in which the respective data held in the buffer memory 122 is written. More specifically, the data management flag 304 indicates which data is the latest data when plural pieces of data having the same address are held in the buffer memory 122. For example, the data management flag 304 has 4 bits. As shown in FIG. 5, data A is held in the data area 302 of a word 0, “000000h” is held in the logical address area 303, and “1” is set in the data management flag 304. In a state in which the data is held in the buffer memory 122, when data B of the same logical address is transmitted from the access device 100, the data B is held in the data area 302 of a word 1, “000000h” is held in the logical address area 303, and “2”, which is information indicating that data of the word 1 is written after the data of word 0 is written, is set in the data management flag 304. In this manner, the CPU 121 can judge which data is the latest data by checking the data management flag 304 of the data having the same address and held in the buffer memory 122.

An operation of the nonvolatile storage device, configured as described above, according to the first embodiment of the present invention is described below with reference to the accompanying drawings.

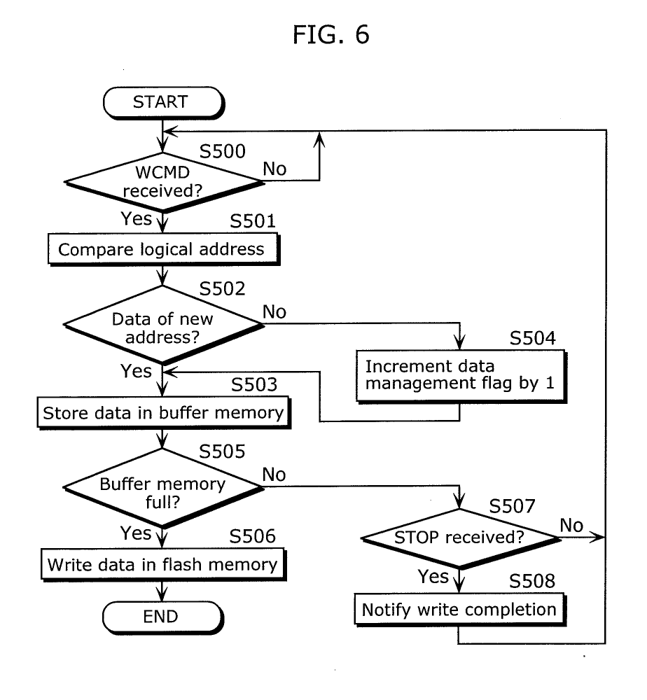

FIG. 6 is a flow chart of a write process of the nonvolatile storage device 110 according to the present embodiment. A series of write operations in which data transferred from the access device 100 is temporarily stored in the buffer memory 122, and, thereafter, the temporarily stored data is written in the flash memory 130 are described below with reference to FIG. 6.

In FIG. 6, the nonvolatile storage device 110 is set in a waiting state of receiving, from the access device 100, a write command (to be referred to as a WCMD hereinafter) (S500). When the CPU 121 receives the WCMD (Yes in S500), the CPU 121 compares a logical sector address of new data inputted from the access device 100 with a logical sector address of the data held in the buffer memory 122 to judge whether or not the logical sector addresses are identical to each other (S501). When data having the same logical address is not present in the buffer memory 122, in other words, when the new data is data having a new address (Yes in S502), a sector worth of data and the logical sector address are temporarily stored in the buffer memory 122 (S503). When data having the same logical sector address is present in the buffer memory 122, in other words, the new data is not data having a new address (No in S502), the CPU 121 changes a value of the data management flag 304 of the new data inputted from the access device 100 into a value obtained by incrementing, by 1, a value of the data management flag 304 of the data of which logical sector address is identical to the logical sector address held in the buffer memory 122 (S504). Then, 1 sector worth of the data and the logical sector address are temporarily stored in the buffer memory 122 (S503). Next, the CPU 121 judges whether or not the buffer memory 122 is full (S505). When the buffer memory 122 is full (Yes in S505), under the control of the CPU 121, the memory control unit 123 writes, in a new page of a predetermined physical block in the flash memory 130, the data held in the buffer memory 122 on a page unit which is a write unit of the flash memory 130 (S506). In this case, the CPU 121, based on the data management flag 304 corresponding to each data, judges data to be written in the flash memory 130. Note that the predetermined physical block is a physical block specified by the address management process, such as the logical physical conversion of the CPU 121, and the description of which physical block is to be specified is omitted.

Furthermore, when the buffer memory 122 has a free space (No in S505), it is checked whether a transfer stop command (to be referred to as a STOP hereinafter) is transferred from the access device 100 (S507). When the STOP is received (Yes in S507), the CPU 121 notifies the access device 100 that writing has been completed (S508).

Note that when 1 sector worth of data is temporarily stored in the buffer memory 122, the access device 100 may be notified that writing has been completed. Furthermore, another buffer memory other than the buffer memory 122 may be prepared, the CPU 121 may temporarily store data newly transferred from the access device 100 in the another buffer memory and compare a logical sector address of the data transferred from the access device 100 with the logical sector address of the data in the buffer memory 122, and the subsequent processes may be executed.

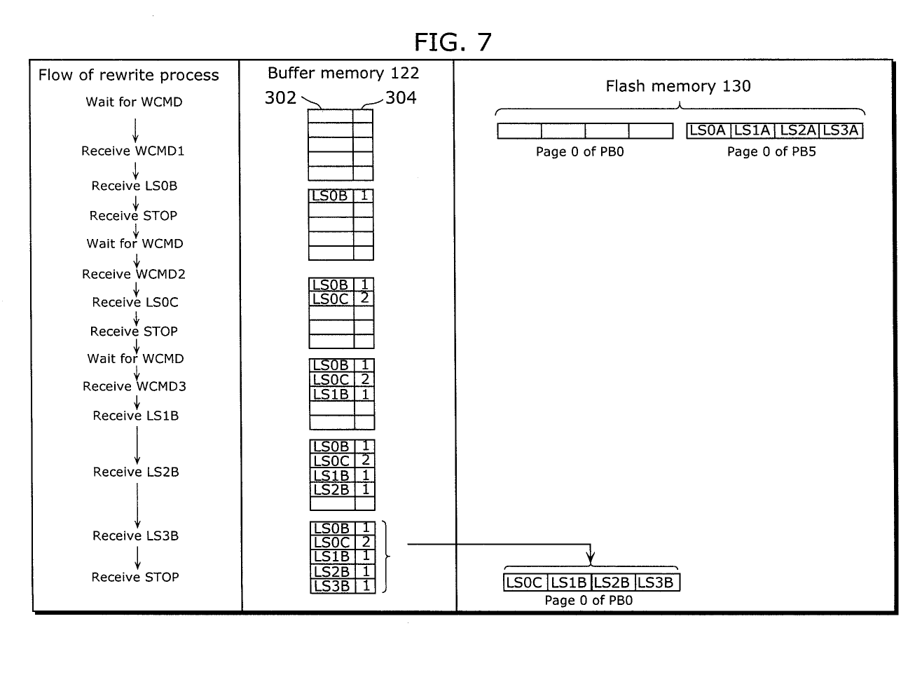

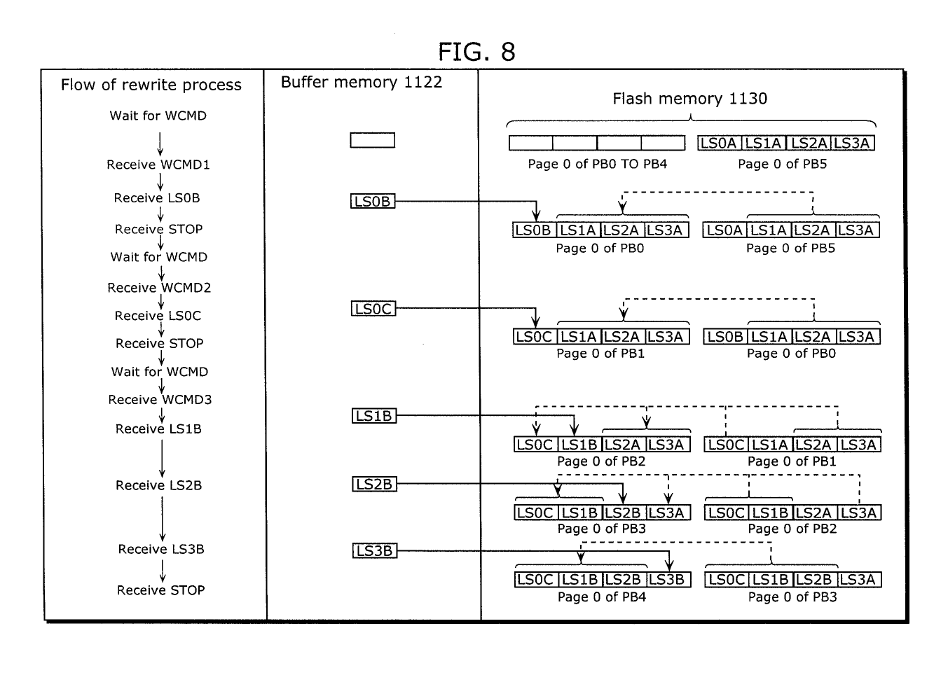

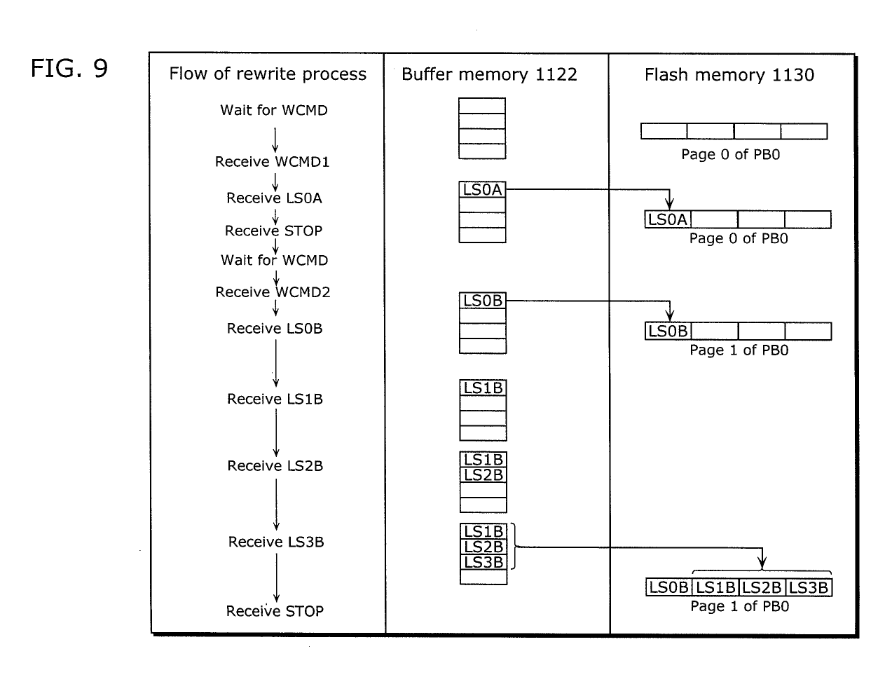

Based on the described write operation of the nonvolatile storage device 110, an example in which the access device 100 rewrites data is described below. Note that in order to make a clear distinction between the present invention and the conventional invention, first, a data rewrite process of the nonvolatile storage device 110 according to the present invention is described with reference to FIG. 7, and next, a data rewrite process of the conventional nonvolatile storage device is described with reference to FIGS. 8 and 9.

FIG. 7 is a diagram showing a flow of the rewrite process of the nonvolatile storage device 110 according to the present embodiment.

In FIG. 7, a WCMD is transferred from the access device 100 three times. The first WCMD is expressed as a WCMD1, the next WCMD is expressed as a WCMD2, and the last WCMD is expressed as a WCMD3. Furthermore, it is assumed that old data LS0A to LS3A of logical sector addresses LS0 to LS3 are held on page 0 of a physical block PB5 in the flash memory 130 and that no data is written on page 0 of a physical block PB0. It is also assumed that the buffer memory 122 does not hold data. Note that although in FIG. 7, in order to simplify the description, the number of words held in the buffer memory 122 is set to be 5, the number of words is not limited to 5.

In the WCMD1, the nonvolatile storage device 110 receives data LS0B of a logical sector address 0 (LS0) and temporarily stores the data LS0B in the buffer memory 122. After the nonvolatile storage device 110 receives the data LS0B, when the access device 100 transfers a STOP signal to the nonvolatile storage device 110, the CPU 121 which receives the data compares a logical sector address of the data held in the buffer memory 122 with the logical sector address (LS0) of the data LS0B to judge whether or not the addresses are identical to each other. Since the logical addresses are not identical to each other, the CPU 121 holds the data LS0B in the buffer memory 122. At this time, since the data LS0B is new data, the data management flag 304 of the data LS0B is set at “1”.

Next, in the WCMD2, 1 sector worth of data LS0C at the logical sector address LS0 is transferred from the access device 100, and, thereafter, a STOP signal is transferred. The CPU 121 compares the logical sector address of the data held in the buffer memory 122 with a logical sector address of the data LS0C. Since the logical sector address (LS0) of the data LS0B transferred in WCMD1 is identical to the logical sector address (LS0) of the data LS0C, the value of the data management flag 304 corresponding to the data LS0C is set at “2” which is a value obtained by incrementing, by 1, a value “1” of the data management flag 304 of the data LS0B held in the buffer memory 122. The CPU 121 holds the data LS0C, the logical address (LS0), and the incremented value “2” of the data management flag 304 in an area different from the area in which the data LS0B of the buffer memory 122 is held.

Thereafter, the access device 100 transfers the WCMD3 and subsequently transfers 3 sectors worth of data (LS1B, LS2B, and LS3B) at logical sector addresses 1 to 3. The data LS1B, LS2B, and LS3B are sequentially and temporarily stored in the buffer memory 122 subsequently to the data LS0B and LS0C. At this time, since the data LS1B, LS2B, and LS3B are plural pieces of data respectively with new addresses, the value of the data management flag 304 corresponding to the data LS1B, LS2B, and LS3B is set at “1”.

When the data LS3B is stored, the buffer memory 122 is full, and the CPU 121 recognizes that the buffer memory 122 is full. The memory control unit 123 transfers the data temporarily stored in the buffer memory 122 to the flash memory 130 in response to a command from the CPU 121 and writes the data. In this case, the CPU 121 recognizes that the data LS0B and LS0C have the same logical address, and checks the data management flag 304 to confirm that the data LS0C is the latest data. More specifically, the CPU 121 obtains information indicating that the data LS0B is old data (data previously written in the buffer memory 122) and invalid based on the value “1” of the data management flag 304 corresponding to the data LS0B and the value “2” of the data management flag 304 corresponding to the data LS0C. Furthermore, the CPU 121 obtains information indicating that the data LS0C is new data (data later written in the buffer memory 122) and valid. The CPU 121 judges the data LS0C is the latest data, transfers the data LS0C, LS1B, LS2B, and LS3B to the flash memory 130, and writes the data in page 0 of the physical block PB0 at one time. In this manner, since the new data LS0C, LS1B, LS2B, and LS3B are written in page 0 of the physical block PB0 at one time, a saving process for old data (LS0A to LS3A) is unnecessary. Although page 0 of the physical block PB5 in which the old data is stored is erased at a certain appropriate time, the erasing operation is so simple that it is omitted from the present description.

An operation of a conventional nonvolatile storage device is described below with reference to FIG. 8. FIG. 8 is a diagram showing a flow of a rewrite process of the conventional nonvolatile storage device.

In FIG. 8, as in FIG. 7, the WCMD1 to WCMD3 are transferred from the access device 100. In the conventional nonvolatile storage device 1110, the data are written from a buffer memory 1122 to a flash memory 1130 on every unit of processing from WCMD to STOP, and the access device 100 is notified that the writing is completed on the every unit. Furthermore, the buffer memory 1122 has 1 sector worth of capacity. In FIG. 8, after the WCMD1 is received, the data LS0B is temporarily stored in the buffer memory. At this time, it is assumed that data LS0A to LS3A have been stored on page 0 of the physical block PB5. It is assumed that the physical blocks PB0 to PB4 in each of which new data is to be written are erased blocks.

The conventional nonvolatile storage device 1110 receives STOP of the WCMD1 and then the data LS0B of the buffer memory 1122 is written in a position of PSN0 on page 0 of the physical block PB0. At the same time, the old data LS1A to LS3A stored on page 0 of the physical block PB5 are written in the positions of PSN1 to PSN3 on page 0 of the physical block PB0.

Next, the data LS0C transferred immediately after the WCMD2 is temporarily stored in the buffer memory 1122, and as in the above description, after STOP is received, the data LS0C of the buffer memory 1122 is written in a position of PSN0 on page 0 of the physical block PB1. At the same time, the data LS1A to LS3A held on page 0 of the physical block PB0 are written in the positions of PSN1 to PSN3 on page 0 of the physical block PB1.

Finally, the data LS1B to LS3B transferred immediately after the WCMD3 are sequentially written in predetermined sector storage positions on page 0 of the physical blocks PB2 to PB4 through the buffer memory 1122. At the same time, the data are saved from the corresponding sector storage positions of the physical blocks PB1 to PB3 in each of which the old data is stored.

The rewrite process of the present invention has been described in comparison with the conventional rewrite process with reference to FIGS. 7 and 8. Since the saving process required in the conventional nonvolatile storage device 1110 is not necessary in the nonvolatile storage device 110 according to the embodiment, the number of times to be written in the flash memory 130 decreases in the nonvolatile storage device 110. For this reason, a rewrite speed of the nonvolatile storage device 110 is apparently higher than that of the nonvolatile storage device 1110. More specifically, the conventional nonvolatile storage device 1110 needs to perform page write five times in the example of the rewrite operation of the data LS0C and the data LS1B to LS3B. However, the nonvolatile storage device 110 according to the present embodiment needs to perform page write only once. Furthermore, the number of times to be written in the nonvolatile storage device 110 according to the present embodiment is fewer than that the number of times to be written in the conventional nonvolatile storage device 1110, and the nonvolatile storage device 110 needs a smaller data area to be used for write. More specifically, since creation of invalid pages can be reduced, the number of times of garbage collection can be reduced. In addition, as the number of times to be written in the flash memory 130 decreases, the lifetime of the nonvolatile storage device can be extended.

Note that FIGS. 7 and 8 describe the example in which the old data is previously stored. However, a case in which old data is not present is described hereinafter. FIG. 9 is a diagram showing a flow of a write process of a conventional nonvolatile storage device when old data is not present. It is assumed that the buffer memory 1122 has 4 sectors worth of capacity as shown in FIG. 9.

In case of WCMD1, data LS0A is written in a corresponding sector storage position on page 0 of a physical block PB0. In case of WCMD2, data LS0B is written in a corresponding sector storage position on page 1 of a physical block PB0. Finally, in case of WMCD3, data LS1B to LS3B are written in corresponding sector positions on page 1 of the physical block PB0. Therefore, as shown in FIG. 9, the conventional nonvolatile storage device in the case where old data is not present needs to perform page write only three times. More specifically, when the old data is not present, in comparison with the case in which data of the same logical sector address is held, a rewrite speed increases. However, in comparison with the nonvolatile storage device 110 according to the present embodiment, data is written in a flash memory many times, and a rewrite speed is apparently low.

A time-divisionally data write method at different storage positions on the same page as shown in FIG. 9 is referred to as divisional writing. For example, although divisional writing can be performed in a single-level cell NAND flash memory, divisional writing is not secured to assure the reliability in a multi-level cell NAND flash memory. Furthermore, even when divisional writing can be performed, the number of times of divisional writing is limited to a specific number. Therefore, in order to realize a reliable nonvolatile storage device, the divisional writing as shown in FIG. 9 can not be applied. In the writing of the nonvolatile storage device 110 according to the present embodiment can reduce the number of times of writing without using divisional writing. With this, high reliability and a high-speed operation can be compatible with each other.

In the nonvolatile storage device 110 according to the present embodiment, old data (LS0B in the example of FIG. 7) is held in the buffer memory 122. In this manner, even when writing fails due to a power supply failure or the like when data (LS0C in the example of FIG. 7) having the logical sector address identical to that of the old data is being written in the buffer memory 122, the old data is not lost.

Note that in the aforementioned description, when the buffer memory 122 is full, data is written in the flash memory 130. However, when at least one page worth of data is held in the buffer memory 122, the data may be written in the flash memory 130. In this case, the CPU 121 does not perform comparison to check whether or not the buffer memory 122 is full in Step S505, but judges whether the buffer memory 122 holds data of a page unit.

In addition, in the aforementioned description, the multi-level cell NAND flash memory 130 is used as the main memory. However, a single-level cell NAND flash memory, or another nonvolatile memory (NOR flash memory, EEPROM, or the like) may be used.

### Second Embodiment

In a nonvolatile storage device according to a second embodiment, when data including the identical logical address is held in the buffer memory 122, new data is overwritten in an area in which old data is held. In this manner, the capacity of the buffer memory 122 can be effectively utilized.

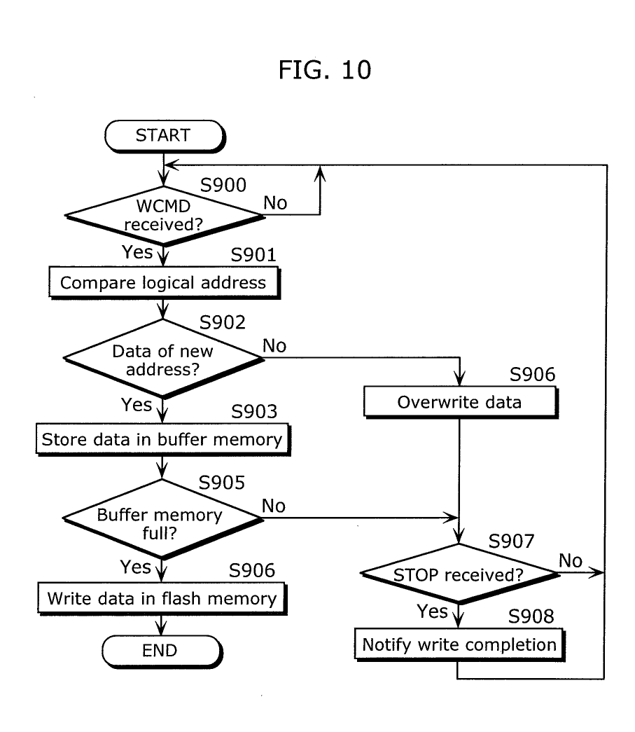

FIG. 10 is a flow chart of a write process of the nonvolatile storage device according to the second embodiment. Since the configuration of the nonvolatile storage device according to the second embodiment is the same as that in FIG. 2, a description thereof is omitted.

As shown in FIG. 10, a write process of the nonvolatile storage device according to the second embodiment is different from the write process in the first embodiment in that when data having the same logical sector address is present in the buffer memory 122 in Step S902 (No in S902), 1 sector worth of new data inputted from an access device 100 and a logical sector address of the data are overwritten in an area in which the data of the same address is held in the buffer memory 122 (S906). After Step S906, it is checked whether STOP is transferred from the access device 100 (S907). Since reception of WCMD (S900), address comparison (S901), processes (Yes in S902 to S905) performed after addresses are not identical to each other, stop reception (S907), and write completion notification (S908) are the same as those in the first embodiment, the description thereof is omitted.

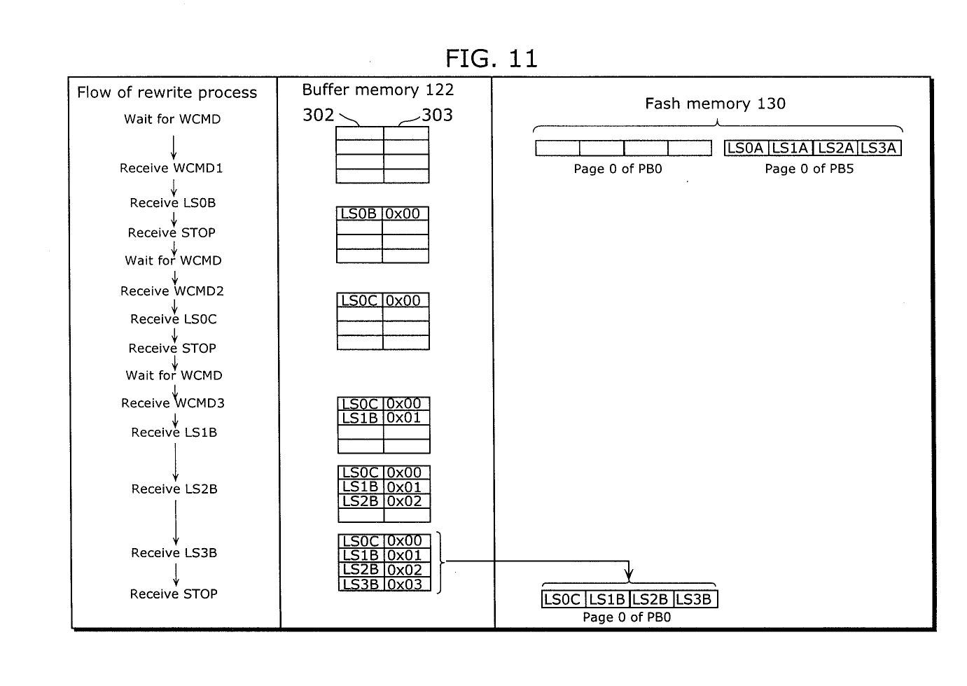

FIG. 11 is a diagram showing a flow of a rewrite process of the nonvolatile storage device according to the second embodiment.

In FIG. 11, WCMD is transferred from the access device 100 three times as in FIG. 7 in the first embodiment. It is assumed that as in FIG. 7, the old data LS0A to LS3A of the logical sector addresses LS0 to LS3 are held on page 0 of the physical block PB5 of the flash memory 130, and no data is written on page 0 of the physical block PB0. Furthermore, it is assumed that the buffer memory 122 does not hold data. Note that although in FIG. 10, for simplifying the description, the number of words held in the buffer memory 122 is assumed to be 4, the number of words is not limited to 4.

In the WCMD1, the nonvolatile storage device 110 receives the data LS0B of a logical sector address 0 (LS0) and temporarily stores the data LS0B in the buffer memory 122. After the nonvolatile storage device 110 receives the data LS0B, when a STOP signal is transferred, the CPU 121 which receives the data compares the logical sector address of the data held in the buffer memory 122 with the logical sector address (LS0) of the data LS0B. Since the logical sector addresses are not identical to each other, the CPU 121 holds the data LS0B in the buffer memory 122.

In the WCMD2, the data LS0C of 1 sector worth of the logical sector address LS0 is transferred from the access device 100, and, thereafter, a STOP signal is transferred. The CPU 121 compares the logical sector address of the data held in the buffer memory 122 with the logical sector address of the data LS0C. Since the logical sector address of the data LS0B transferred in the WCMD1 is identical to the logical sector address of the data LS0C, the CPU 121 overwrites the new data (LS0C) in an area of the buffer memory 122 in which the old data (LS0B) is held.

Thereafter, the access device 100 transfers the WCMD3 and subsequently transfers 3 sectors worth of data (LS1B, LS2B, and LS3B) of logical sector addresses 1 to 3 (LS1 to LS3). Since the data LS1B, LS2B, and LS3B are plural pieces of data respectively with new addresses, the data LS1B, LS2B, and LS3B are temporarily stored in a free space of the buffer memory 122 subsequently after LS0B and LS0C are held.

When the data LS3B is stored, the buffer memory 122 becomes full, and the CPU 121 recognizes that the buffer memory 122 is full. The memory control unit 123 transfers the data temporarily stored in the buffer memory 122 to the flash memory 130 in response to a command from the CPU 121 and writes the data. The CPU 121 transfers the data LS0C, LS1B, LS2B, and LS3B to the flash memory 130 and writes the data on page 0 of the physical block PB0 at one time. Therefore, since the new data LS0C, LS1B, LS2B, and LS3B are written on page 0 of the physical block PB0 at one time, the saving process for the old data is not necessary.

As described above, in the nonvolatile storage device according to the second embodiment, data can be written on a page unit at one time as in the first embodiment. It is obvious that such nonvolatile storage device is superior to the conventional nonvolatile storage device in the write operation. Furthermore, in the second embodiment, when data of the identical logical address is held in the buffer memory 122, new data is overwritten in an area in which old data is held, and thus the capacity of the buffer memory 122 can be effectively utilized. Furthermore, there is an advantage in that the data management flag 304 becomes unnecessary. In the aforementioned description, the buffer memory 122 is assumed to have the capacity of 4 sectors. However, by increasing the capacity of the buffer memory 122 further, more data can be temporarily held, and data can be overwritten when data of the same address is received. For this reason, efficiency of writing can be further improved.

### Third Embodiment

A nonvolatile storage device according to a third embodiment includes a notifying unit which notifies a CPU 121 that a buffer memory 122 is full. In this manner, the processes of the CPU 121 can be reduced.

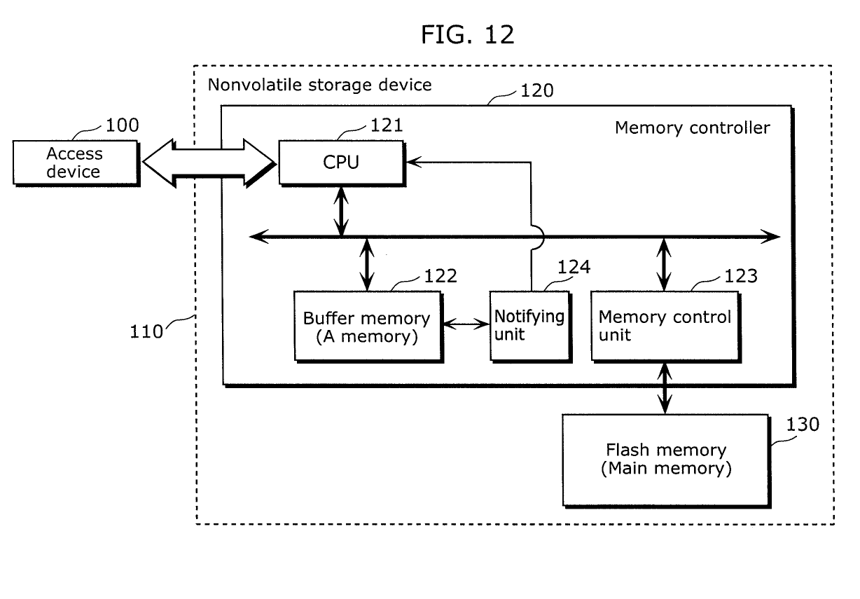

FIG. 12 is a block diagram showing a configuration of a nonvolatile storage system according to the third embodiment. The reference numerals identical to that of FIG. 2 are used in FIG. 12, and the detailed description thereof is omitted.

The nonvolatile storage device 110 according to the third embodiment shown in FIG. 12 is different from that of the first embodiment shown in FIG. 2 in that a memory controller 120 includes a notifying unit 124. The notifying unit 124 is implemented by hardware, judges whether or not the buffer memory 122 is full, and notifies the CPU 121 of a result of the judgment. The CPU 121 controls the memory control unit 123 based on the result of the judgment notified by the notifying unit 124 and writes data held in the buffer memory 122 in the flash memory 130.

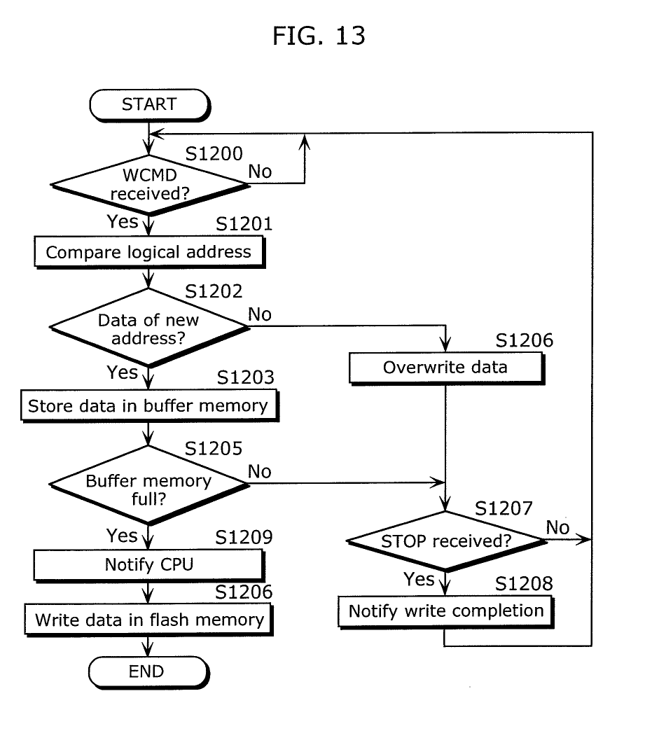

FIG. 13 is a flow chart of a write process of the nonvolatile storage device 110 according to the third embodiment.

A series of write operations in which data transferred from the access device 100 is temporarily stored in the buffer memory 122, and, thereafter, the temporarily stored data is written in the flash memory 130 is described hereinafter with reference to FIG. 13.

In FIG. 13, the operations from receiving of WCMD to judgment whether or not the buffer memory 122 is full (S1200 to S1205) are the same as those in the second embodiment shown in FIG. 10.

When the buffer memory 122 is full (Yes in S1205), the notifying unit 124 notifies the CPU 121 that the buffer memory 122 is full (S1209). In response to the notification signal, the CPU 121 writes the data on a page unit which is a write unit of the flash memory 130 in a predetermined physical block of the flash memory 130, using the memory control unit 123 (S1206).

As described above, in the nonvolatile storage device 110 according to the third embodiment, the notifying unit 124 notifies the CPU 121 that the buffer memory 122 is full. In this manner, a timing at which the data held in the buffer memory 122 is written in the flash memory 130 need not be checked each time the CPU 121 writes data in the buffer memory 122, and the CPU 121 has only to receive only a signal from the buffer memory 122. For this reason, the process sequence of the CPU 121 can be simplified. Furthermore, since the notifying unit 124 as the hardware judges whether or not the buffer memory 122 is full, and notifies the CPU 121 of a result of the judgment, the processes can be performed at a high speed.

### Fourth Embodiment

In a nonvolatile storage device according to a fourth embodiment, the data management flag 304 judges whether or not a buffer memory 122 is full. In this manner, the free space availability in the buffer memory 122 can be easily judged.

A configuration of the nonvolatile storage device 110 according to the fourth embodiment is the same as that of FIG. 2, and a flow chart of a write process in the fourth embodiment is the same as that of FIG. 6.

The CPU 121 of the nonvolatile storage device 110 according to the fourth embodiment is different from that of the first embodiment in that the CPU 121 judges whether or not the buffer memory 122 is full based on the number of valid data management flags 304 held in the buffer memory 122 in Step S505 in FIG. 6. For example, a value of the data management flag 304 of unnecessary data (data previously written in the flash memory 130 and the like) is set at “0”. A value of the data management flag 304 in a free space in which no data is written is also set at “0”. In this case, the CPU 121 checks the data management flag 304 in the buffer memory 122. When data having the data management flag 304 indicating “0” is not present, the CPU 121 can judge that the buffer memory 122 is full.

As described above, the nonvolatile storage device 110 according to the fourth embodiment checks the data management flag 304 so that the CPU 121 can easily judge whether or not the buffer memory 122 is full. In this manner, the notifying unit 124 or the like described in the third embodiment which determines a timing at which the data held in the buffer memory 122 is written in the flash memory 130 is not necessary. Thus, the circuit configuration of the nonvolatile storage device 110 can be simplified.

### Fifth Embodiment

A nonvolatile storage device according to a fifth embodiment writes data in a buffer memory 122 after judging whether or not the buffer memory 122 is full. In this manner, since a timing at which the data is written in the flash memory 130 can be delayed, the capacity of the buffer memory 122 can be effectively used.

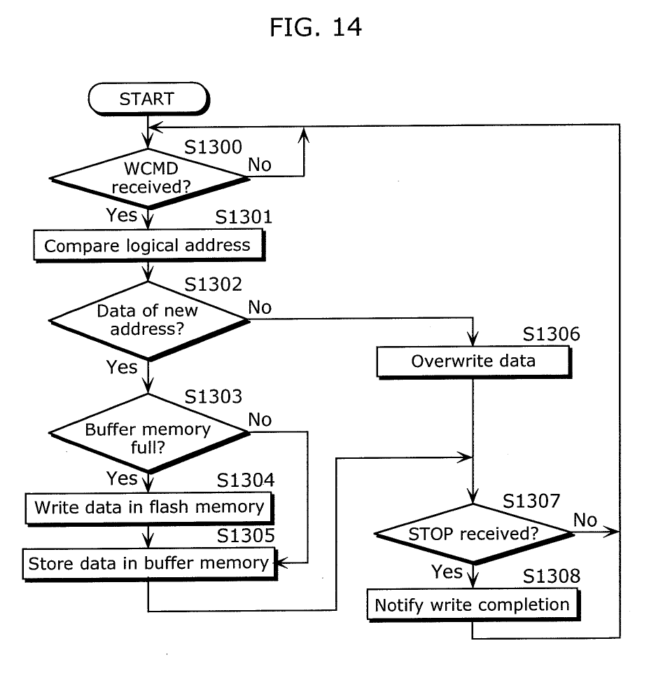

FIG. 14 is a flow chart of a write process of the nonvolatile storage device 110 according to the fifth embodiment. Note that a configuration of the nonvolatile storage device 110 according to the fifth embodiment is the same as that of FIG. 2.

In FIG. 14, the nonvolatile storage device 110 is set in a waiting state of receiving, from the access device 100, a write command (S1300). When the nonvolatile storage device 110 receives WCMD (Yes in S1300), the CPU 121 compares a logical sector address of data transferred from the access device 100 with a logical sector address of data held in the buffer memory 122 (S1301). When data having the same logical sector address is not present in the buffer memory 122 (Yes in S1302), the CPU 121 judges whether or not the buffer memory 122 is full (S1303). In this case, when the number of different addresses in Step S1302 is equal to the number of data which can be held in the buffer memory 122, the buffer memory 122 is judged to be a full buffer memory. For example, it is assumed that the buffer memory 122 can hold up to data of eight words. When three pieces of valid data are held in the buffer memory 122, the number of different addresses in Step S1302 is three and is not equal to eight which is the number of data which can be held in the buffer memory 122. More specifically, the CPU 121 judges that the buffer memory 122 is not full. Furthermore, when it is assumed that the buffer memory 122 holds eight valid data, as the number of different addresses in Step S1302 is eight, this corresponds to the number of data which can be held in the buffer memory 122. More specifically, the CPU 121 judges that the buffer memory 122 is full.

When the buffer memory 122 is full (Yes in S1303), data is written from the buffer memory 122 into a predetermined physical block of the flash memory 130 on a page unit which is a write unit of the flash memory 130 (S1304). After Step S1304, 1 sector worth of data inputted from the access device 100 and a logical sector address of the data are temporarily stored in the buffer memory 122 (S1305). When the buffer memory 122 is not full (No in S1303), after Step S1303, the 1 sector worth of data inputted from the access device 100 and the logical sector address of the data are temporarily stored in the buffer memory 122 (S1305). Note that since a process performed when data having the same logical sector address is present in the buffer memory 122 (No in S1302) is the same as that of the second embodiment shown in FIG. 10, the description thereof is omitted.

As described above, the nonvolatile storage device 110 according to the fifth embodiment judges whether or not the buffer memory 122 is full and then writes, in the buffer memory 122, data newly inputted from the access device 100. Therefore, the subsequent processes are continued even when the buffer memory 122 is full by writing, in the buffer memory 122, the data newly inputted from the access device 100. More specifically, when the buffer memory 122 is full, the data transferred from the access device 100 is then compared with the data held in the buffer memory 122, and then, the subsequent processes can be determined. Therefore, when data having the same address is received, even when the buffer memory 122 is full, the data may be overwritten, and a timing at which the data is written in the flash memory 130 can be delayed. Furthermore, the capacity of the buffer memory 122 can be effectively used. Therefore, the number of times to be written in the flash memory 130 can be reduced.

Furthermore, the nonvolatile storage device 110 according to the fifth embodiment judges that the buffer memory 122 is full when the number of different addresses in Step S1302 is equal to the number of data which can be held in the buffer memory 122. In this manner, the notifying unit 124 or the like which determines a timing at which the data held in the buffer memory 122 is written in the flash memory 130 is not necessary, and the circuit configuration of the system can be simplified. Furthermore, based on the number of different addresses which is information obtained by the process in Step S1302, it is judged whether or not the buffer memory 122 is full. For this reason, a flag or the like indicating that the buffer memory 122 is full need not be provided, and the capacity of the buffer memory 122 can be reduced.

### Sixth Embodiment

A nonvolatile storage device according to a sixth embodiment lowers a priority level of writing, in the flash memory 130, data of a frequently updated logical sector address, which makes it possible to reduce the number of times to be written in the flash memory 130.

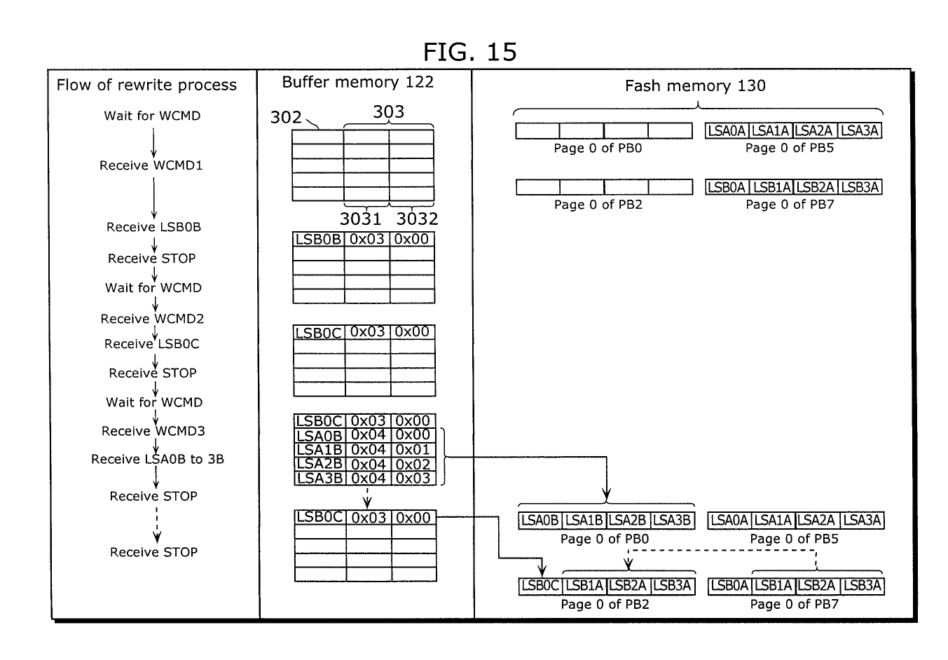

FIG. 15 is a diagram showing a flow of a rewrite process of the nonvolatile storage device according to the sixth embodiment. A configuration of the nonvolatile storage device according to the sixth embodiment is the same as that of FIG. 2.

In FIG. 15, data LSB0B and LSB0C transferred by WCMD1 and WCMD2 are data which is held in a specific area of the flash memory 130 and is frequently rewritten. It is assumed that data LSA0B to LSA3B to be transferred by WCMD3 are sequentially written data such as photographic data or music data, and are not frequently rewritten. Furthermore, the flash memory 130 holds data LSA0A to SLA3A of logical sector addresses LSA0 to LSA3 on page 0 of a physical block PB5, and holds data LSB0A to LSB3A of logical sector addresses LSB0 to LSB3 on page 0 of a physical block PB7. Furthermore, it is assumed that page 0 of a physical block PB0 of the flash memory 130 and page 0 of a physical block PB2 do not hold data. In FIG. 15, although the number of words held in the buffer memory 122 is assumed to be 5 for simplifying the description, the number of words is not limited to 5. The logical sector address 303 held in the buffer memory 122 includes a logical block address 3031 and a logical page address 3032.

In WCMD1, the nonvolatile storage device 110 receives the data LSB0B having a logical block address 3031 of “0x03” and a logical sector address 3032 of “0x00” (logical sector address LSB0) and temporarily stores the data LSB0B in the buffer memory 122. The access device 100 transfers the data LSB0B in the WCMD1 and then transfers a STOP signal. The CPU 121 which receives the data LSB0B compares a logical sector address of the data LSB0B with a logical sector address of data held in the buffer memory 122. Since data of the same logical sector address is not present in the buffer memory 122, the CPU 121 holds the data LSB0B in the buffer memory.

Next, the access device 100 transfers the data LSB0C having a logical sector address identical to the logical sector address of LSB0B (logical sector address LSB0) in the WCMD2. Thereafter, the access device 100 transfers a STOP signal. At this time, the CPU 121 compares the logical sector address of the data held in the buffer memory 122 with the logical sector address of the data LSB0C. Both the logical sector address of the data LSB0C transferred in the WCMD1 and the logical sector address of the data LSB0B held in the buffer memory 122 are the logical sector address LSB0 (the logical block address 3031 is “0x03” and the logical sector address 3032 is “0x00”), and are identical to each other. For this reason, the data LSB0B held in the buffer memory 122 is overwritten on the data LSB0C transferred in the WCMD2. Furthermore, the CPU 121 also judges whether or not the data of the logical sector address LSB0 is data repeatedly and frequently updated. Since the data of the logical sector address LSB0 is sequentially inputted from the access device 100, the CPU 121 recognizes the data of the logical sector address LSB0 as specific data to be frequently updated and sets, as a specific area, the data and the address area of the buffer memory 122 in which the data LSB0C is held. The specific data held in the specific area is written in the flash memory 130 at a priority level lower than that of the data held in an area other then the specific area.

Thereafter, the access device 100 transfers WCMD3 and transfers 4 sectors worth of data, LSA0B to LSA3B of the logical sector addresses LSA0 to LSA3. Since the data LSA0B to LSA3B are data of new addresses, the data LSA0B to LSA3B are sequentially and temporarily stored in the buffer memory 122.

When the data LSA3B is stored, the buffer memory 122 becomes full, and the CPU 121 recognizes that the buffer memory 122 is full. The memory control unit 123 transfers the data temporarily stored in the buffer memory 122 to the flash memory 130 in response to a command from the CPU 121. More specifically, the memory control unit 123 writes the data LSA0B to LSA3B on page 0 of the physical block PB0 on a page unit. Since the CPU 121 recognizes the data LSB0C as data to be frequently updated, the data LSB0C is kept in the buffer memory 122 and is not transferred at this timing. Each time data of the same logical address (LSB0) is transferred from the access device 100, data of the logical sector address LSB0 held in the specific area of the buffer memory 122 is overwritten. Upon completion of the writing of data from the access device 100, data held in the specific area of the buffer memory 122 is transferred to the flash memory 130 and written on page 0 of the physical block PB2.

As described above, in the nonvolatile storage device 110 according to the sixth embodiment, in writing of specific data (directory entry, key information, or the like) to be frequently rewritten, the data is updated in the buffer memory 122 and written in the flash memory 130 at the end of the process. In this manner, each time specific data is received, the data need not be written in the flash memory 130. A speed to be written in the flash memory 130 can be increased. Since the number of times to be rewritten in the flash memory 130 can be reduced, the lifetime of the nonvolatile storage device 110 can be extended.

Note that a method of causing the CPU 121 to specify data held in a specific area of the buffer memory 122 is not limited to a specific method, although the following methods are conceivable, such as: a method used when plural pieces of data of the same logical addresses are received twice or more; a method used when data of a certain logical address is transferred once, then continuous addresses of a plurality of other sectors are transferred, and data of the same logical address is received.

Furthermore, it is described that a timing at which the data held in the specific area of the buffer memory 122 is transferred to the flash memory 130 is a timing after writing of data from the access device 100 is completed or a timing after data of another new logical address is judged to be data of the specific address. However, the timing is not limited to the specific timing.

The specific area set in the buffer memory 122 is set on a sector unit in the aforementioned description. However, the area may be set on a page unit, and the unit is not limited to a specific unit.

### Seventh Embodiment

A nonvolatile storage device according to a seventh embodiment lowers a priority level in which data of a specific logical sector address is written in the flash memory 130, which makes it possible to reduce the number of times to be written in the flash memory 130.

In the sixth embodiment, the CPU 121 judges data to be frequently rewritten, and a priority level in which data to be frequently rewritten is written in the flash memory 130 is lowered. However, in the seventh embodiment, a logical sector address of data to be frequently rewritten is set as a specific address in advance, and it is judged whether or not a logical sector address of data inputted from the access device 100 is identical to the specific address. When the address is judged as the specific address, specific data having the specific address is written in the flash memory 130 at a priority level lower than that of data other than the specific data. Note that a flow of a rewrite process in the seventh embodiment is the same as that of FIG. 15, and the description thereof is omitted.

As described above, when data (FAT data or the like) of a specific address is written, data is updated in the buffer memory 122, the data is written in the flash memory 130 at the end of the process. For this reason, since the data need not be written in the flash memory 130 each time the data of the specific address is received, a write speed for the flash memory 130 can be increased. Furthermore, since the number of times to be rewritten in the flash memory 130 can be reduced, the lifetime of the nonvolatile storage device 110 can be extended.

### Eighth Embodiment

A nonvolatile storage device according to an eighth embodiment holds, in the buffer memory 122, a specific area flag indicating whether or not data held in a buffer memory 122 is data to be frequently rewritten. With this, a plurality of specific areas can be set, and the capacity of the buffer memory 122 can be effectively used.

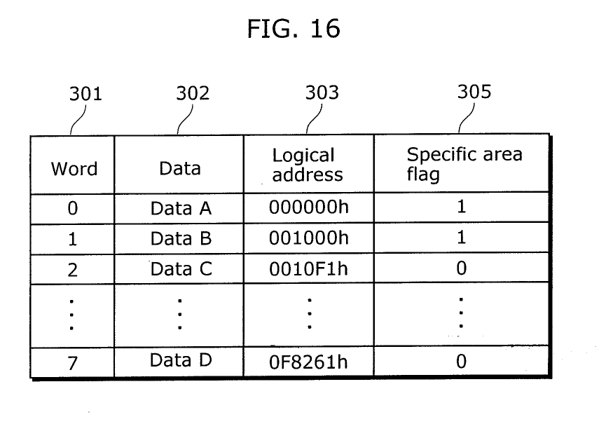

FIG. 16 is a diagram showing a format of data held in the buffer memory 122 of the nonvolatile storage device 110 according to the eighth embodiment. The reference numerals identical to that of FIG. 5 are used in FIG. 16, and the detailed description thereof is omitted. A configuration of the nonvolatile storage device 110 according to the eighth embodiment is the same as that of FIG. 2.

As shown in FIG. 16, in the buffer memory 122 of the nonvolatile storage device 110 according to the eighth embodiment, each data includes a 1-bit specific area flag 305. The specific area flag 305 is a flag indicating whether or not each data is data in a specific area. For example, when the specific area flag 305 is “0”, the data is normal data. When the specific area flag 305 is “1”, the data is data in a specific area. In the specific area, data to be frequently rewritten is set, for example, directory entry, key information, FAT data, or the like. For example, as shown in FIG. 16, since data of word 0 has the specific area flag 305 of “1”, data of the logical address 303 of “000000h” is data in the specific area. The specific data having the specific area flag 305 of “1” is written in the flash memory 130 at a priority level lower than that of data other than the specific data.

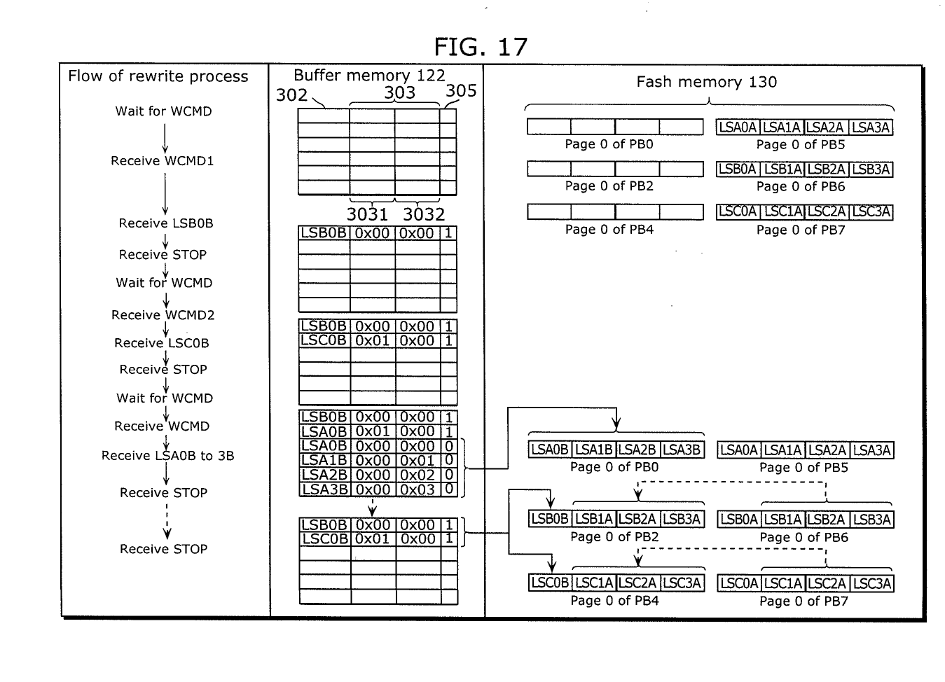

FIG. 17 is a diagram showing a flow of a rewrite process of the nonvolatile storage device 110 according to the eighth embodiment.

In FIG. 17, data LSA0A to LSA3A of logical sector addresses LSA0 to LSA3 are held on page 0 of a physical block PB5 of the flash memory 130, data LSB0A to LSB3A of the logical sector addresses LSB0 to LSB3 are held on page 0 of a physical block PB6, and data LSC0A to LSC3A of the logical sector addresses LSC0 to LSC3 are held on page 0 of a physical block PB7. Furthermore, it is assumed that no data are written on page 0 of the physical block 0, page 0 of the physical block PB2, and page 0 of a physical block PB4. Note that although in FIG. 17, the number of words held in the buffer memory 122 is assumed to be 6 for simplifying the description, the number of words is not limited to 6.

Furthermore, data LSB0B and LSC0B respectively transferred by WCMD1 and WCMD2 are data held in a certain specific area of the flash memory 130 and to be frequently rewritten. The data LSA0B to LSA3B transferred by WCMD3 are sequentially written data such as photographic data or music data, and are not very frequently rewritten.

In the WCMD1, the nonvolatile storage device 110 receives the data LSB0B with the logical sector address LSB0 (the logical block address “0x00” and logical page address “0x00”) and temporarily stores the data LSB0B in the buffer memory 122. The access device 100 transfers the data LSB0B and then transfers a STOP signal. The CPU 121 which receives the data recognizes the data as data of a specific address based on the logical sector address of the data LSB0B, and compares the logical sector address of the data held in the buffer memory 122 with the logical sector address of the data LSB0B. Since the same logical address is not present in the buffer memory 122, the CPU 121 holds the data LSB0B in the buffer memory 122, and the specific area flag 305 corresponding to the held data is set at “1”. In this case, as a method of causing the CPU 121 to recognize the input data as data of a specific address, an address to be frequently updated may be used for the judgment as in the sixth embodiment, or the data may be identified by comparison with a predetermined specific address as described in the seventh embodiment.

Next, in the WCMD2, the access device 100 transfers the data LSC0B and then transfers a STOP signal. The CPU 121 recognizes the data as the data of the specific address according to the logical sector address of the data LSC0B, and compares the logical sector address of the data held in the buffer memory 122 with the logical sector address of the data LSC0B. Since the same logical sector address is not present in the buffer memory 122, the CPU 121 holds the data LSC0B in the buffer memory 122 and sets, at “1”, the specific area flag 305 corresponding to the held data.

Thereafter, the access device 100 transfers the WCMD3 and transfers 4 sectors worth of data LSA0B, LSA1B, LSA2B, and LSA3B of the logical sector addresses LSA0 to LSA3. Since the data LSA0B to LSA3B are plural pieces of data respectively with new addresses, the data are sequentially and temporarily stored in the buffer memory 122. In this case, since the data LSA0B, LSA1B, LSA2B, and LSA3B are not plural pieces of data with specific addresses, the corresponding specific area flags 305 are set at “0”.

When the data LSA3B is stored, the buffer memory 122 becomes full, and the CPU 121 recognizes that the buffer memory 122 is full. The memory control unit 123 transfers, to the flash memory 130, data temporarily stored in the buffer memory 122 and having the specific area flag 305 of “0” in response to a command of the CPU 121. More specifically, the memory control unit 123 writes the data LSA0B to LSA3B on page 0 of the physical block PB0 on a page unit. The CPU 121 recognizes that the specific area flag 305 in a data area in which the data LSB0B and LSC0B are held is “1” and keeps the data in the buffer memory 122. In this manner, each time plural pieces of data of the same logical addresses (LSB0 and LSC0) are transferred from the access device 100, the data held in the specific area of the buffer memory 122 is overwritten. Finally, when writing of data from the access device 100 is finished, the memory control unit 123 transfers, to the flash memory 130, the data in which the specific area flag 305 is “1” in the buffer memory 122. More specifically, the memory control unit 123 writes the data LSB0B on page 0 of the physical block PB2 and writes the data LSC0B on page 0 of the physical block PB4.

As described above, in the nonvolatile storage device according to the eighth embodiment, even when plural pieces of specific data (directory entry, key information, FAT data, or the like) to be frequently rewritten are transferred, the CPU 121 judges the data to be data in a specific area, sets, at “1”, the specific area flag 305 of the buffer memory 122, and holds the data in the area. In this manner, since a space of the specific area of the buffer memory 122 can be freely set, even when plural pieces of specific data are transferred, specific areas may be set in the data individually, and the capacity of the buffer memory 122 can be effectively used. Furthermore, when the CPU 121 merely checks the specific area flag 305 in data transfer to the flash memory 130, whether or not the data must be transferred can be judged. Since the CPU 121 need not be always recognize the specific area, a process sequence can be simplified. In this manner, since the specific data can be rewritten within the buffer memory 122, the number of times to be written in the flash memory 130 can be reduced, and a write speed of the nonvolatile storage device 110 can be increased. Furthermore, since the number of times to be rewritten in the flash memory 130 can be reduced, the rewriting lifetime of the nonvolatile storage device 110 can be extended.

In this case, a timing at which the data held in the specific area of the buffer memory 122 is transferred to the flash memory 130 is a timing after the access device 100 has written data, or a timing after it is judged that plural pieces of data of logical addresses, each of the number of which is equal to or larger than a certain predetermined number are plural pieces of data of specific addresses. However, the timing is not limited to a specific timing.

Furthermore, as means which designates a part of the buffer memory 122 as a specific area, the specific area flag 305 is used in the description. However, the specific area may be managed in the CPU 121, and the means is not limited to a specific means.

Furthermore, although the specific area set in the buffer memory 122 is set on a sector unit in the aforementioned description. However, the area may be set on a page unit, and the unit is not limited to a specific unit.

### Ninth Embodiment

A nonvolatile storage device according to a ninth embodiment holds a write completion flag indicating whether or not data is correctly written in a buffer memory 122 in the buffer memory 122. In this manner, in the case where data is not correctly written in the buffer memory 122 due to a power supply failure or the like, which data is valid can be easily judged, and the reliability can be improved.

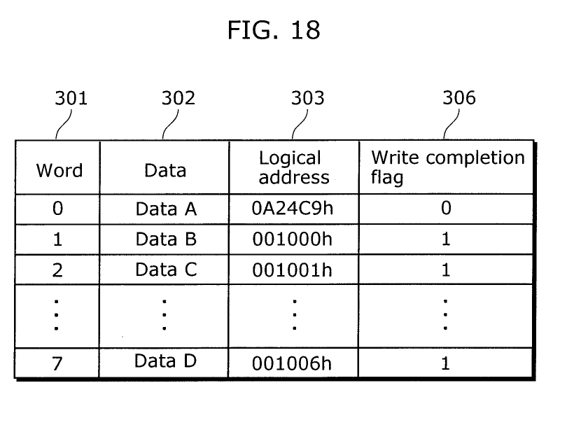

FIG. 18 is a diagram showing a format of data held in the buffer memory 122 of the nonvolatile storage device 110 according to the ninth embodiment. The reference numerals identical to that of FIG. 5 are used in FIG. 18, and the detailed description thereof is omitted. Furthermore, a configuration of the nonvolatile storage device 110 according to the ninth embodiment is the same as that of FIG. 2.

As shown in FIG. 18, the buffer memory 122 of the nonvolatile storage device 110 according to the ninth embodiment includes a 1-bit write completion flag 306 in each data. The write completion flag 306 is a flag indicating that each data is correctly written in the buffer memory 122. For example, the write completion flag 306 of data which is not correctly written in the buffer memory 122 due to a power supply failure or the like is set at “0”, and the write completion flag 306 of data which is correctly written in the buffer memory 122 is set at “1”. The data of word 0 shown in FIG. 18 is invalid data which has the write completion flag 306 of “0” and is not correctly written in the buffer memory 122. The data of word 1 is data which has the write completion flag 306 of “1” and which is correctly written in the buffer memory 122. After the data of the buffer memory 122 is transferred to the flash memory 130, the write completion flag 306 of the transferred data is set at “0”. The write completion flag 306 in an area in which no data is written is set at “0”. In this manner, the CPU 121 checks the write completion flag 306, which makes it possible to easily check the free space availability of a data holding area of the buffer memory 122.

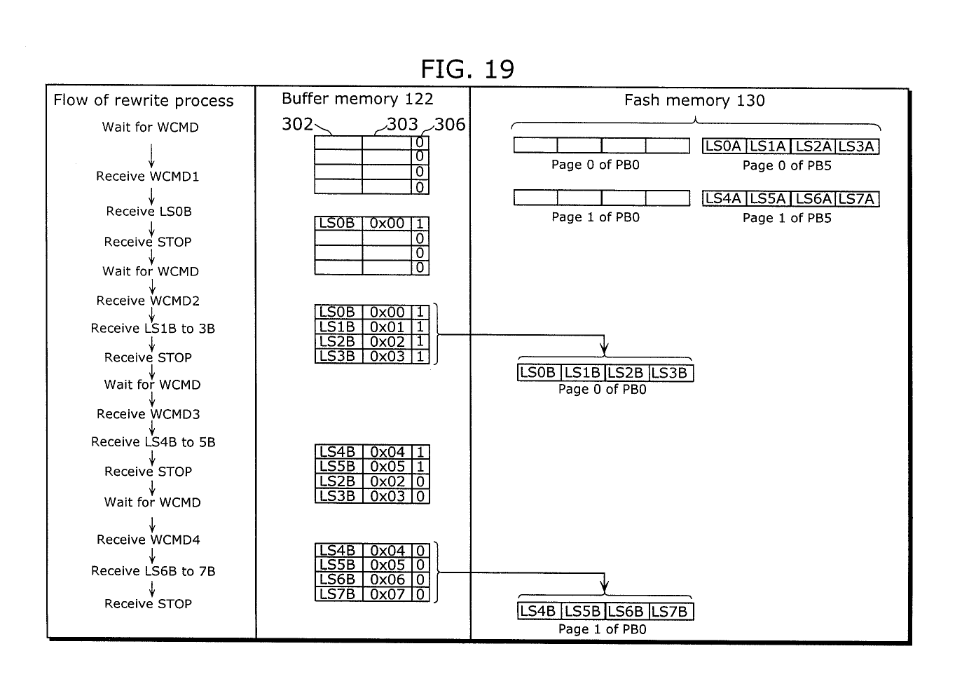

FIG. 19 is a diagram showing a flow of a rewrite process of the nonvolatile storage device 110 according to the ninth embodiment. In FIG. 19, WCMD is transferred from the access device 100 to the nonvolatile storage device 110 four times. The first WCMD is expressed as WCMD1, the next WCMD is expressed as WCMD2, the other next WCMD is expressed as WCMD3, and the final WCMD is expressed as WCMD4. The data LS0A to LS3A of logical sector addresses LS0 to LS3 are held on page 0 of a physical block PB5 of the flash memory 130, and data LS4A to LS7A of logical sector addresses LS4 to LS7 are held on page 1 of the physical block PB5. Furthermore, it is assumed that no data is written on page 0 and page 1 of a physical block 0. Note that in FIG. 19, the number of words held in the buffer memory 122 is assumed to be 4 for simplifying the description. However, the number of words is not limited to 4. Furthermore, no data is written in the buffer memory 122, and the write completion flags 306 corresponding to all data areas is set at “0”.

In the WCMD1, the nonvolatile storage device 110 receives data LS0B of a logical sector address LS0 (“0x00”) and temporarily stores the data LS0B in the buffer memory 122. The access device 100 transfers the data LS0B in the WCMD1 and then transfers a STOP signal. The CPU 121 which receives the data LS0B compares the logical sector address of the data held in the buffer memory 122 with the logical sector address of the data LS0B. Since the same logical sector address is not present, the CPU 121 holds the data LS0B in the buffer memory 122. At this time, when the data is correctly written, the write completion flag 306 corresponding to the data LS0B is set at “1”. Note that when the data LS0B is not correctly written due to a power supply failure or the like, the write completion flag 306 is maintained at “0”.

Next, in the WCMD2, the access device 100 transfers data LS1B to LS3B and then transfers a STOP signal. The CPU 121 compares the logical sector addresses of the data LS1B to LS3B with the logical sector address of the data held in the buffer memory 122 to confirm whether the logical sector addresses are not identical to each other. The CPU 121 holds the data LS1B to LS3B in a new area of the buffer memory 122. As in case of the data LS0B, when the data LS1B to LS3B are correctly written, the write completion flags 306 corresponding to the data LS1B to LS3B in the buffer memory 122 are set at “1”. When the data LS3B is stored, the buffer memory 122 becomes full, and the CPU 121 recognizes that the buffer memory 122 is full. The memory control unit 123 transfers the data temporarily stored in the buffer memory 122 to the flash memory 130 in response to a command from the CPU 121. The memory control unit 123 writes the data LSA0B to LSA3B on page 0 of the physical block PB0 on a page unit. At this time, the values of the write completion flags 306 of the buffer memory 122 corresponding to the data LS0B to LS3B which have been written in the flash memory 130 are set at “0”. The CPU 121 checks the values of the write completion flag so that the CPU 121 can recognize the free space availability of the buffer memory 122 and an area in which data is allowed to be written next in the buffer memory 122.

In the WCMD3, the access device 100 transfers 2 sectors worth of data LS4B and LS5B, and then transfers a STOP signal. As in the WCMD1 and WCMD2, the CPU 121 compares the logical sector addresses of the data LS4B and LS5B with logical sector addresses of plural pieces of data held in the buffer memory 122. The CPU 121 checks that data of the same logical sector address is not present in the buffer memory 122, and holds the data LS4B and LS5B in an area in which the write completion flag 306 is “0” in the buffer memory 122. At this time, the write completion flags 306 corresponding to the data LS4B and LS5B in the buffer memory 122 are set at “1”.

In the WCMD4, data LS6B and LS7B are transferred from the access device 100 and held in an area having the write completion flag 306 of “0” in the buffer memory 122. The write completion flags 306 corresponding to the data LS6B and LS7B in the buffer memory 122 are set at “1”. When the data LS6B and LS7B are held in the buffer memory 122, the buffer memory 122 becomes full. As in the flow of the WCMD2, the data LS4B to LS7B are transferred to page 1 of the physical block PB0 in the flash memory 130. After the data LS4B to LS7B are written in the flash memory 130, the write completion flags 306 of the data LS4B to LS7B in the buffer memory 122 are set at “0”.

As described above, the nonvolatile storage device 110 according to the ninth embodiment holds, in the buffer memory 122, the write completion flag 306 indicating whether or not the data transferred from the access device 100 is correctly written in the buffer memory 122. In this manner, it is possible to check whether or not the data transmitted to the buffer memory 122 is correctly written in the buffer memory 122, and the reliability of data to be written can be improved. After the data in the buffer memory 122 is transferred to the flash memory 130, the write completion flag 306 in the buffer memory 122 is returned to “0”, so that the CPU 121 can recognize which area of the buffer memory 122 the newly transferred data should be written. With this, efficiency of data processing can also be improved.

### Tenth Embodiment

A nonvolatile storage device according to a tenth embodiment holds a transfer completion flag indicating whether or not data held in the buffer memory 122 is correctly written in the flash memory 130. In this manner, when writing in the flash memory 130 fails due to a power supply failure, which data is not correctly written can be judged, and the reliability can be improved.

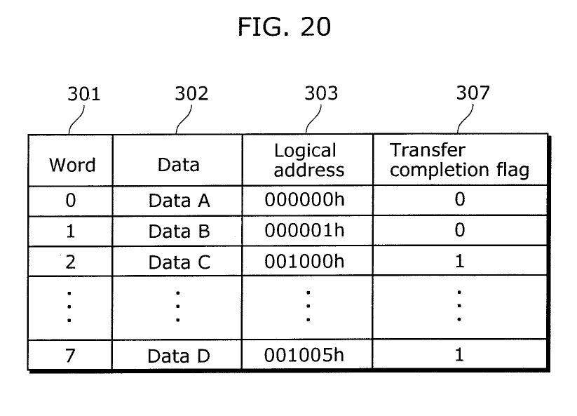

FIG. 20 is a diagram showing a format of data held in the buffer memory 122 of the nonvolatile storage device 110 according to the tenth embodiment. The reference numerals identical to that of FIG. 5 are used in FIG. 20, and the detailed description thereof is omitted. Furthermore, a configuration of the nonvolatile storage device 110 according to the tenth embodiment is the same as that of FIG. 2.

As shown in FIG. 20, the buffer memory 122 of the nonvolatile storage device 110 according to the tenth embodiment includes a 1-bit transfer completion flag 307 in each data. The transfer completion flag 307 is a flag indicating whether or not each data is correctly written from the buffer memory 122 into the flash memory 130. For example, the transfer completion flag 307 corresponding to data which is not written in the flash memory 130 is set at “0”. Furthermore, the transfer completion flag 307 corresponding to data which is not correctly written in the flash memory 130 due to a power supply failure or the like is also set at “0”. The transfer completion flag 307 corresponding to data which is correctly written in the flash memory 130 is set at “1”. For example, data of word 0 shown in FIG. 20 is data which has the transfer completion flag 307 of “0” and is not written in the flash memory 130 or data which is not correctly written in the flash memory 130. Data of word 2 is data which has the transfer completion flag 307 of “1” and which is correctly written in the flash memory 130.

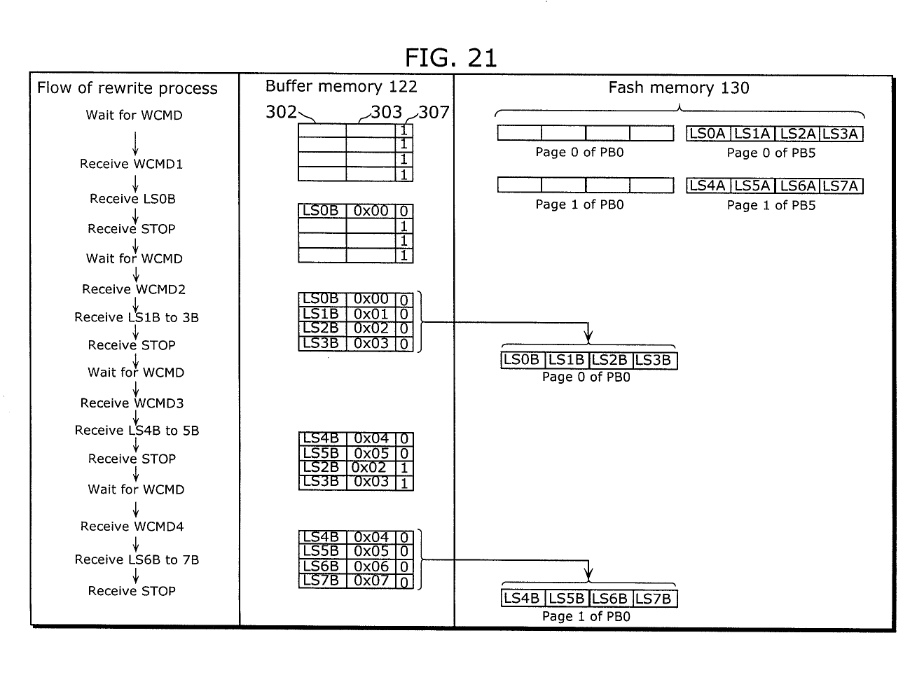

FIG. 21 is a diagram showing a flow of a rewrite process of the nonvolatile storage device 110 according to the tenth embodiment.

In FIG. 21, WCMD is transferred from the access device 100 four times. The first WCMD is expressed as WCMD1, the next WCMD is expressed as WCMD2, the other next WCMD is expressed as WCMD3, and the final WCMD is expressed as WCMD4. Data LS0A to LS3A of logical sector addresses LS0 to LS3 are held on page 0 of a physical block PB5 of the flash memory 130, and data LS4A to LS7A of logical sector addresses LS4 to LS7 are held on page 1 of the physical block PB5. Furthermore, it is assumed that no data is written on page 0 and page 1 of a physical block 0. Note that in FIG. 21, the number of words held in the buffer memory 122 is assumed to be 4 for simplifying the description. However, the number of words is not limited to 4. Furthermore, no data is written in the buffer memory 122, and the transfer completion flags 307 corresponding to all data areas are set at “1”.

In the WCMD1, the nonvolatile storage device 110 receives data LS0B of a logical sector address LS0 (“0x00”) and temporarily stores the data LS0B in the buffer memory 122. The access device 100 transfers the data LS0B in the WCMD1 and then transfers a STOP signal. The CPU 121 which receives the data LS0B compares the logical sector address of the data held in the buffer memory 122 with the logical sector address of the LS0B. Since the same logical sector address is not present, the CPU 121 holds the data LS0B in the buffer memory 122. At this time, since the data LS0B is data which is not written in the flash memory 130, the transfer completion flag 307 corresponding to the area in which the data LS0B is held is set at “0”.

Next, in the WCMD2, the access device 100 transfers data LS1B to LS3B and then transfers a STOP signal. The CPU 121 compares the logical sector addresses of the data LS1B to LS3B with the logical sector address of the data held in the buffer memory 122 to confirm whether the logical sector addresses are not identical to each other. The CPU 121 holds the data LS1B to LS3B in a new area of the buffer memory 122. As in case of the data LS0B, since the data are not written in the flash memory 130, the transfer completion flag 307 corresponding to the data area in which the data are held in the buffer memory 122 is set at “0”.

When the data LS3B is stored, the buffer memory 122 is full, and the CPU 121 recognizes that the buffer memory 122 is full. The memory control unit 123 transfers the data temporarily stored in the buffer memory 122 to the flash memory 130 in response to a command from the CPU 121. More specifically, the memory control unit 123 writes the data LSA0B to LSA3B on page 0 of the physical block PB0 on a page unit. At this time, the values of the transfer completion flags 307 in the buffer memory 122 which are corresponding to the data LS0B to LS3B which have been written in the flash memory 130 are set at “1”. When writing fails due to a power supply failure or the like during writing of the data LS0B to LS3B, the transfer completion flags 307 are maintained at “0”. The CPU 121 checks the values of the transfer completion flags 307 so as to recognize the free space availability of the buffer memory 122 and an area in which new data is allowed to be written next in the buffer memory 122. More specifically, the CPU 121 can judge that the data having the transfer completion flag 307 of “1” is data which has been written in the flash memory 130 and that new data can be written in the buffer memory 122.

In the WCMD3, the access device 100 transfers 2 sectors worth of data LS4B and LS5B and then transfers a STOP signal. As in the WCMD1 and WCMD2, the CPU 121 compares the logical sector addresses of the data LS4B and LS5B with the logical sector addresses of the plural pieces of data held in the buffer memory 122. The CPU 121 confirms that data of the same logical sector address is not present in the buffer memory 122, and the CPU 121 holds the data LS4B and LS5B in an area in which the transfer completion flag 307 is “1” in the buffer memory 122 and sets the transfer completion flags 307 corresponding to the data LS4B and LS5B at “0”.

In the WCMD4, data LS6B and LS7B are transferred from the access device 100. The CPU 121 holds the data LS6B and LS7B in an area having the transfer completion flag 307 of “1” in the buffer memory 122 and in which the data LSB2B and LSB3B are held. The transfer completion flags 307 corresponding to the data LS6B and LS7B in the buffer memory 122 are set at “0”. When the data LS6B and LS7B are held in the buffer memory 122, the buffer memory 122 becomes full. As in the flow of the WCMD2, the data LS4B to LS7B are transferred to page 1 of the physical block PB0 in the flash memory 130. After the data LS4B to LS7B are written in the flash memory, the transfer completion flags 307 corresponding to the data LS4B to LS7B in the buffer memory 122 are set at “1”.

As described above, the nonvolatile storage device 110 according to the tenth embodiment holds the transfer completion flag 307 indicating whether or not the data held in the buffer memory 122 is correctly written in the flash memory 130. In this manner, it is possible to check whether or not the data transmitted to the buffer memory 122 is correctly written in the flash memory 130, and the reliability of data to be written in the flash memory 130 can be improved. After the data held in the buffer memory 122 is transferred to the flash memory 130, by setting the transfer completion flag at “1”, the CPU 121 can recognize an area in which newly transferred data is allowed to be written in the buffer memory 122, and efficiency of data processing can also be improved.

### Eleventh Embodiment

A nonvolatile storage device according to an eleventh embodiment writes data held in the buffer memory 122 in the flash memory 130 when the buffer memory 122 becomes full. In this manner, the number of times to be written in the flash memory 130 can be reduced. A configuration of the nonvolatile storage device 110 according to the eleventh embodiment is the same as that of FIG. 2.

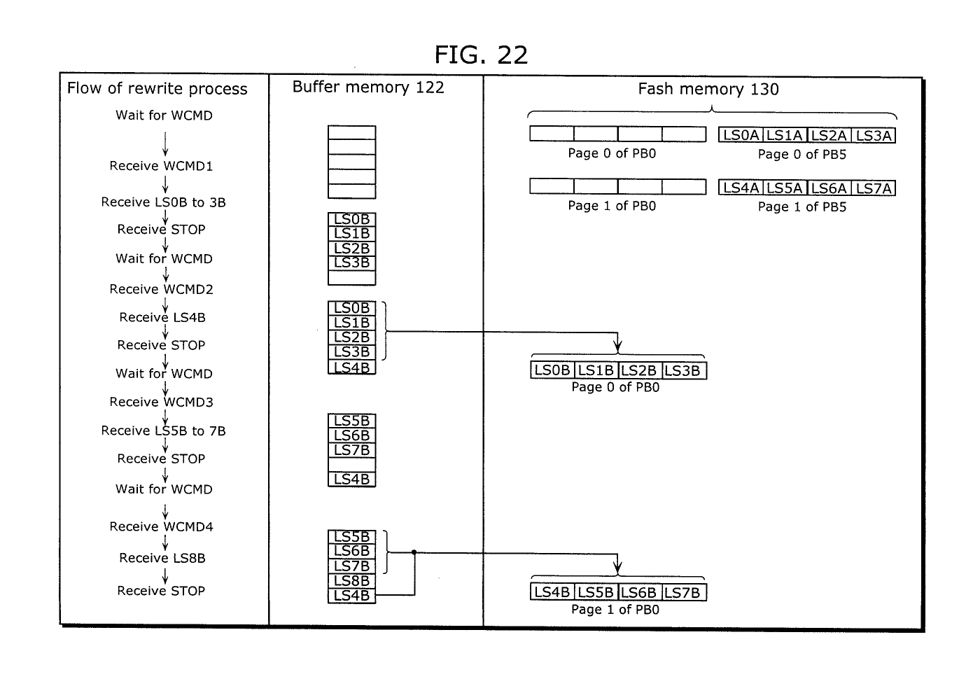

FIG. 22 is a diagram showing a flow of a rewrite process of the nonvolatile storage device 110 according to the eleventh embodiment. In FIG. 22, WCMD is transferred from the access device 100 four times. The first WCMD is expressed as WCMD1, the next WCMD is expressed as WCMD2, the other next WCMD is expressed as WCMD3, and the final WCMD is expressed as WCMD4. Data LS0A to LS3A of logical sector addresses LS0 to LS3 are held on page 0 of a physical block PB5 of the flash memory 130, and data LS4A to LS7A of logical sector addresses LS4 to LS7 are held on page 1 of the physical block PB5. Furthermore, it is assumed that no data is written on page 0 and page 1 of a physical block 0. Note that in FIG. 22, the number of words held in the buffer memory 122 is assumed to be 5 for simplifying the description. However, the number of words is not limited to 5.

In the WCMD1, the nonvolatile storage device 110 receives data LS0B to LS3B of logical sector addresses LS0 to LS3 and temporarily stores the data LS0B to LS3B in the buffer memory 122. The access device 100 transfers 4 sectors worth of data LS0B to LS3B and then transfers a STOP signal. The CPU 121 which receives the data compares the logical sector addresses of the data LS0B to LS3B with the logical sector address held in the buffer memory 122. Since the same logical sector address is not present, the CPU 121 holds the data LS0B to LS3B in the buffer memory 122.

Next, in the WCMD2, the access device 100 transfers data LS4B of a logical sector address LS4 and then transfers a STOP signal. The CPU 121 compares the logical sector address of the data LS4B with the logical sector addresses of the plural pieces of data held in the buffer memory 122. Since the same logical address is not present in the buffer memory 122, the CPU 121 holds the data LS4B in the buffer memory 122. At the same time, the CPU 121 recognizes that the data LS4B of the logical sector address LS4 is data of a logical sector address subsequent to the logical sector addresses LS0 to LS3 of the data LS0B to LS3B transferred in the WCMD1. When the data LS4B is stored, the buffer memory 122 becomes full, and the CPU 121 recognizes that the buffer memory 122 is full. The memory control unit 123 transfers the data temporarily stored in the buffer memory 122 to the flash memory 130 in response to a command from the CPU 121, and writes the data on page 0 of the physical block PB0 at one time. At this time, since the data held in page 0 are the data LS0A to LS3A of the logical sector addresses LS0 to LS3, the CPU 121 judges that the data LS4B is data which is less than a page size and keeps the data in the buffer memory 122 without being transferred to the flash memory 130.

Thereafter, the access device 100 transfers the WCMD3 and subsequently transfers 3 sectors worth of data LS5B to LS7B of logical sector addresses LS5 to LS7. Since the data LS5B to LS7B are plural pieces of data of new addresses, the data LS5B to LS7B are temporarily stored in the buffer memory 122.

Then, in the WCMD4, data LS8B is transferred form the access device 100, and the buffer memory 122 becomes full. The CPU 121 recognizes that the buffer memory 122 is full, transfers the data LS4B to LS7B temporarily stored in the buffer memory 122 to the flash memory 130, using the memory control unit 123, and writes the data on page 1 of the physical block PB0 at one time. The CPU 121 judges the data of the logical sector address LS8 to be data which is less than a page size and keeps the data in the buffer memory 122.

As described above, the nonvolatile storage device 110 according to the eleventh embodiment writes data in the flash memory 130 when the buffer memory 122 is full. In this manner, when plural pieces of data are sequentially transferred on a unit smaller than a page unit, or when the transferred data is not transferred from the start but transferred halfway or from the end, the data on the same page need not be written in the flash memory 130 more than once, and the data can be written at one time. Therefore, efficiency of writing of data can be improved. Furthermore, since the number of times to be written in the flash memory 130 can be reduced, the rewriting lifetime of the flash memory 130 can be extended.

Note that in the aforementioned description, a timing at which the data held in the buffer memory 122 is transferred to the flash memory 130 is a timing at which the buffer memory 122 becomes full. However, the timing may be a timing after writing of data from the access device 100 is completed or a timing after the order of the logical sector addresses of plural pieces of data sequentially transferred are changed to another order.

### Twelfth Embodiment

A nonvolatile storage device according to a twelfth embodiment includes an address comparing unit 125 which is implemented by hardware and compares a logical sector address of data held in the buffer memory 122 with a logical sector address of data newly transferred from the access device 100. In this manner, load of processes performed by the CPU 121 can be reduced.

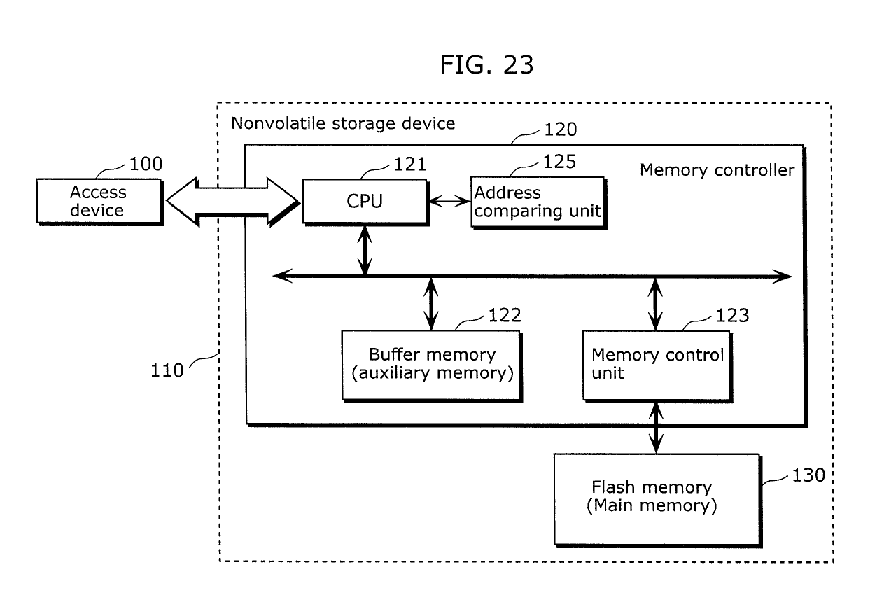

FIG. 23 is a block diagram of a nonvolatile storage system according to the twelfth embodiment. The nonvolatile storage system shown in FIG. 23 includes the nonvolatile storage device 110 and the access device 100. The nonvolatile storage device 110 shown in FIG. 23 is different from that of the first embodiment shown in FIG. 2 in that the nonvolatile storage device 110 shown in FIG. 23 includes the address comparing unit 125. The reference numerals identical to that of FIG. 2 are used in FIG. 23, and the detailed description thereof is omitted.

The address comparing unit 125 compares the logical sector address of data newly transferred from the access device 100 with the logical sector address of data stored in the buffer memory 122 to check whether or not the logical sector addresses are identical to each other. The address comparing unit 125 is implemented by hardware. Furthermore, the address comparing unit 125 connected to the CPU 121 via a special bus.

As described above, the nonvolatile storage device 110 according to the twelfth embodiment includes a special address comparing unit 125 which compares the logical sector address of the data transferred from the access device 100 with the logical sector address of the data held in the buffer memory 122. In the first embodiment, the CPU 121 compares the logical sector address of the data transferred from the access device 100 with the logical sector address of the data held in the buffer memory 122, however; the subsequent processes must be determined. In the twelfth embodiment, the address comparing unit 125 performs the comparing process as the hardware. Furthermore, the special us is provided between the CPU 121 and the address comparing unit 125 to execute the processes. Therefore, the load on the CPU 121 can be reduced. Furthermore, the comparing operation can be performed at a high speed.

Although the present invention has been fully described by way of examples with reference to the accompanying drawings, it is to be noted that various changes and modifications is apparent to those skilled in the art. Therefore, unless otherwise such changes and modifications depart from the scope of the present invention, they should be construed as being included therein.

### INDUSTRIAL APPLICABILITY

The present invention can be applied to a nonvolatile storage device, in particular, to a nonvolatile storage device used for a recording medium of: a portable audio-visual apparatus, such as a still image recording/reproducing apparatus or a moving image recording/reproducing apparatus; or a portable communication apparatus, such as a cellular phone.

What is claimed is:

1. A nonvolatile storage device into which data is inputted from an external device on a sector unit, said device comprising:
a main memory which is nonvolatile and in which data is written on a page unit, the page unit being larger than the sector unit;
an auxiliary memory which holds at least a single page worth of the input data;
a memory judging unit operable to judge whether or not data held in said auxiliary memory is equal to or larger than data of the page unit; and
a memory control unit operable to write, in a new page of said main memory on the page unit, the data held in said auxiliary memory when said memory judgment unit judges that the data held in said auxiliary memory is equal to or larger than data of the page unit.

2. The nonvolatile storage device according to claim 1,
wherein said auxiliary memory holds the input data and an address of the input data,
said nonvolatile storage device further comprises:
an address judgment unit operable to judge whether or not the address held in said auxiliary memory is identical to an address of data inputted newly from the external device; and
a CPU operable to write the new input data in said auxiliary memory, and to control said memory control unit,
wherein said auxiliary memory holds data management flags each of which indicates an order in which each held data is written, and
said CPU is operable to:
write the new input data in an area different from an area in which data judged to be identical to the new input data in said auxiliary memory is held when said address judgment unit judges that the address held in said auxiliary memory is identical to the address of the new input data;
set information in a data management flag corresponding to the new input data, the information indicating that the new input data is written after the data judged to be identical to the new input data is written; and
determine data which said memory control unit writes in said main memory, based on the data management flag.

3. The nonvolatile storage device according to claim 2,
wherein said memory judgment unit is operable to judge whether or not said auxiliary memory is full, and
said memory control unit is operable to write, in said main memory, the data held in said auxiliary memory when said memory judgment unit judges that said auxiliary memory is full.

4. The nonvolatile storage device according to claim 2,
wherein said memory judgment unit is implemented by hardware,
said nonvolatile storage device further comprises
a notifying unit operable to notify said CPU of a result of the judgment made by said memory judgment unit,
said CPU is operable to control said memory control unit based on the result of the judgment notified by said notifying unit, and
said memory control unit is operable to write, in the new page of said main memory on the page unit, the data held in said auxiliary memory under the control of said CPU.

5. The nonvolatile storage device according to claim 2,
wherein said memory judgment unit is operable to judge whether or not said auxiliary memory is full based on the number of valid data management flags held in said auxiliary memory.

6. The nonvolatile storage device according to claim 2,
wherein said address judgment unit is implemented by hardware.

7. The nonvolatile storage device according to claim 1,
wherein said auxiliary memory holds the input data and an address of the input data,
said nonvolatile storage device further comprises:
an address judgment unit operable to judge whether or not an address held in said auxiliary memory is identical to an address of data inputted newly from the external device; and
a CPU operable to write the new input data in said auxiliary memory, and to control said memory control unit, and
when said address judgment unit judges that the address held in said auxiliary memory is identical to the address of the new input data, said CPU is operable to overwrite the new input data in an area in which data judged to be identical to the new input data in said auxiliary memory is held.

8. The nonvolatile storage device according to claim 7,
wherein said memory judgment unit is operable to judge whether or not said auxiliary memory is full, and
when said memory judgment unit judges that said auxiliary memory is full, said memory control unit is operable to write, in said main memory, the data held in said auxiliary memory.

9. The nonvolatile storage device according to claim 7,
wherein said memory judgment unit is implemented by hardware,
said nonvolatile storage device further comprises
a notifying unit operable to notify said CPU of a result of the judgment made by said memory judgment unit,
said CPU is operable to control said memory control unit based on the result of the judgment notified by said notifying unit, and
said memory control unit is operable to write, in the new page of said main memory on the page unit, the data held in said auxiliary memory under the control of said CPU.

10. The nonvolatile storage device according to claim 7,
wherein said memory judgment unit is operable to judge whether or not said auxiliary memory is full,
when said memory judgment unit judges that said auxiliary memory is full, said memory control unit is operable to write, in said main memory, the data held in said auxiliary memory, and
said CPU is operable to write the new input data in said auxiliary memory after the judgment of said memory judgment unit is made.

11. The nonvolatile storage device according to claim 1, further comprising
an updating judgment unit operable to judge whether or not the input data is frequently updated,
wherein specific data which is data judged to be frequently updated by said updating judgment unit is written in said main memory in order of priority, the priority of the specific data being lower than a priority of data other than the specific data.

12. The nonvolatile storage device according to claim 11,
wherein said auxiliary memory holds a specific area flag indicating whether or not each held data is the specific data.

13. The nonvolatile storage device according to claim 11,
wherein an area in which the specific data is held can be freely set in said auxiliary memory.

14. The nonvolatile storage device according to claim 1, further comprising
a specific address judgment unit operable to judge whether or not an address of the input data is identical to a specific address,
wherein specific data which is data having the specific address is written in said main memory in order of priority, the priority of the specific data being lower than a priority of data other than the specific data.

15. The nonvolatile storage device according to claim 14,
wherein said auxiliary memory holds a specific area flag indicating whether or not each held data is the specific data.

16. The nonvolatile storage device according to claim 1,
wherein said auxiliary memory holds a write completion flag indicating whether or not each held data is correctly written in said auxiliary memory.

17. The nonvolatile storage device according to claim 1,
wherein said auxiliary memory holds a transfer completion flag indicating whether or not each held data is written in said main memory.

18. The nonvolatile storage device according to claim 1,
wherein said auxiliary memory is a nonvolatile RAM.

19. The nonvolatile storage device according to claim 18,
wherein said auxiliary memory is one of a ferroelectric memory, a magnetoresistive random access memory, an ovonic unified memory, and a resistance RAM.

20. A data writing method for use in a nonvolatile storage device including a nonvolatile main memory in which data is inputted from an external device on a sector unit and in which data is written on a page unit, the page unit being larger than the sector unit, said method comprising:
holding the input data in an auxiliary memory;
judging whether or not data held in said auxiliary memory is equal to or larger than data of the page unit; and
writing, in a new page of the main memory on the page unit, the data held in the auxiliary memory when said judging judges that the data held in said auxiliary memory is equal to or larger than data of the page unit.
